(19) United States
(12) Patent Application Publication
(10) Pub. No.: US 2025/0371038 A1
(43) Pub. Date: Dec. 4, 2025

(54) PARTITIONED ROW LIMITING

(71) Applicant: Oracle International Corporation, Redwood Shores, CA (US)

(72) Inventors: Yuan Zhou, Foster City, CA (US); Angela Amor, Menlo Park, CA (US); Andrew Witkowski, Foster City, CA (US); Aurosish Mishra, Foster City, CA (US); Shasank Kisan Chavan, Belmont, CA (US); Tirthankar Lahiri, Palo Alto, CA (US)

(21) Appl. No.: 19/303,489

(22) Filed: Aug. 19, 2025

Related U.S. Application Data
(63) Continuation-in-part of application No. 18/885,640, filed on Sep. 14, 2024.
(60) Provisional application No. 63/583,259, filed on Sep. 16, 2023.
(60) Provisional application No. 63/583,298, filed on Sep. 17, 2023.
(60) Provisional application No. 63/563,926, filed on Mar. 11, 2024.

(51) Int. Cl. G06F 16/28; G06F 16/2455; G06F 16/248

(52) U.S. Cl. CPC G06F 16/288; G06F 16/24562; G06F 16/248

(57) ABSTRACT

A query is received for stored data items that have a plurality of attributes that include a first attribute and a second attribute that has a hierarchical relationship with the first attribute. A first sort of the stored data items is performed based on a first set of ordering keys that include the first attribute and the second attribute. A second sort of the stored data items is performed based on a second set of one or more ordering keys, the second set being a proper subset of the first set and including the second attribute as an ordering key. First pointers to the stored data items are inserted into a first sorted structure of the second sort of the stored data items. Second pointers to the stored data items are inserted into a second sorted structure of the second sort of the stored data items.

### BENEFIT CLAIM AND RELATED APPLICATION

This application claims the benefit as a continuation-in-part of U.S. patent application Ser. No. 18/885,640, filed Sep. 14, 2024, which claims the benefit of U.S. Provisional Patent Application No. 63/563,926, filed Mar. 11, 2024, U.S. Provisional Patent Application No. 63/583,298, filed Sep. 17, 2023, and U.S. Provisional Patent Application No. 63/583,259, filed Sep. 16, 2023, the entire contents of which are hereby incorporated by reference.

This application is related to Application Serial No. xxxx, filed on even date herewith, [Docket No. 50277-6573], titled PARTITIONED ROW LIMITING, the entire contents of which is hereby incorporated by reference.

### FIELD

The present invention relates to queries for data in a database and, more specifically, to partitioned row limiting of query results and partitioned sorting with duplicate elimination on non-sort keys.

### BACKGROUND

A vector is a fixed-length sequence of numbers, typically floating-point numbers, such as [21.4, 45.2, 675.34, 19.4, 83.24], which is a five-dimensional vector. An embedding is a means of representing objects (e.g., text, images, and audio) as points in a continuous vector space where the locations of those points in space are semantically meaningful to one or more machine learning (ML) techniques. An embedding is often represented as a vector. Generically, a vector embedding represents a point in N-dimensional space. Vector embeddings are intended to capture the important “features” of the data that the vector embeddings represent (or embed). The data a vector embedding represents can be one of many types of data, such as a document, an email, an image, or a video. Examples of features are color, size, category, location, texture, meaning, and concept. Each feature is represented by one or more numbers (dimensions) in the vector embedding. Hereinafter, a “vector embedding” is referred to as a “vector.”

### Distance between Vectors

An important attribute of vectors is that the distance between two vectors is a good proxy for the similarity of the objects represented by the vectors. Two vectors that represent similar data should be a short distance from each other in vector space. The opposite is also true: dissimilar data are represented by vectors that are far apart from each other in the vector space. For example, the distance between a vector for the word “cat” and a vector for the word “dog” should be less than the distance between the vector for the word “cat” and a vector for the word “plant.”

The distance between two vectors is often calculated by summing the squares of the difference between the numbers in each position of the vectors:

$$( Vector 1 [ 1 ] - Vector 2 [ 1 ] ) \hat{} 2 + ( Vector 1 [ 2 ] - Vector 2 [ 2 ] ) \hat{} 2 + …$$

The property that vector distance represents object similarity is what allows similar data to be found using a vector database. For example, when a vector representing a picture of a dog is searched for in a vector database, the nearest vectors will be those representing other dogs, not vectors representing plants.

### Multi-Vector Queries

Multi-vectors describe scenarios in which a single entity or object has multiple vectors. For example, text documents can be chunked into pages, paragraphs, sentences, and words, which can be considered hierarchical attributes. In a hierarchy of attributes, there are multiple values of a lower-level attribute for each value of a higher-level attribute, such as multiple words per sentence. In another example, data about a person can be chunked into multiple different photos. Other examples of entities can be audio recordings, videos, and other entities. Each chunk of entity data can be embedded into a different vector, where the vectors conceptually represent the entity. When searching for an entity, candidate entities are matched based on the closest chunk vector within the entity to a given query vector.

For example, when a user performs a search using a search engine, a document on a website can include many relevant paragraphs. A vector search with a user query can match some of the paragraphs in one document on one website and another document on another website. The user may not want to see all matching paragraphs from a single document in their top results. Instead, the user may only want to see a specified number of paragraphs per document in the top documents.

A complex query for such a search for the top 10 matching documents could be written to retrieve all of the chunks and the results can be post-processed. For example, a search could be performed that retrieves a thousand chunks regardless of which document they are part of, and the results can be post-processed. In the post-processing steps, the best match is returned per document until the desired number of documents is retrieved, and the remaining results are discarded. However, such a post-processing approach may still not retrieve the top 10 documents. The post-processing approach is also cumbersome in terms of processor and memory efficiency because it retrieves more results than necessary. The post-processing approach is further cumbersome in terms of expressing the search in SQL.

### Database Queries

Single entities are also often represented by multiple hierarchical attributes in a database. For example, an employee can be a member of a team, a department, and an organization. The team can be part of the department, which can be part of the organization. When searching for a specific number of top departments with the top employee salaries, a complex query could be written to retrieve all of the top employees, and the results would be post-processed. For example, a search could be performed that retrieves the top thousand employees regardless of which department they are part of, and the results would be post-processed. In the post-processing steps, the best employee is returned per department until the desired number of departments is retrieved, and the remaining results are discarded. However, post-processing such database queries suffers from the same deficiencies as post-processing vector queries.

As a further example, a user may desire to fetch employees from departments ordered by salary, where the goal is to get the top two organizations based on salary, the top two departments within the top two organizations based on salary, with the top two employees ordered by salary per department. Such a query is complex and would involve an extensive window function or other elaborate query operations to obtain the desired results.

Additionally, the sorting of results may sometimes require semantic comparison. Consider the following example object type definition and its order member function:

```
-- define object type
create or replace type office_type as object (
  office_no number(10), location varchar2(30),
  order member function compare (obj office_type) return
number
);
/
-- define compare method
create or replace type body office_type as
order member function compare (obj office_type) return
number is
  begin
    if office_no < obj.office_no then
      return −1;
    elsif office_no > obj.office_no then
      return 1;
    else
      return 0;
    end if;
  end;
end;
/
```

Consider the following table creation:

```
-- create table with custom data type
create table_tab_adt_emp (emp_no number(10),
  dept_no number(10),
  office_info office_type);
```

Also, consider the following values for office types:

OFFICE_INFO (OFFICE_NO, LOCATION)
OFFICE_TYPE (6, ‘office110’)
OFFICE_TYPE (11, ‘office104’)
OFFICE_INFO (OFFICE_NO, LOCATION)
OFFICE_TYPE (79, ‘office113’)
OFFICE_TYPE (79, ‘office118’)

Just looking at the bytes shows OFFICE_TYPE(6, ‘office110’) is different from OFFICE_TYPE(11, ‘office104’). Also, OFFICE_TYPE(79, ‘office113’) is different from OFFICE_TYPE(79, ‘office118’). However, the compare order member function must be used when comparing two OFFICE_TYPE values. Even though office113 and office118 look different, they should be considered duplicates because they have the same office_no value of 79, and this is what the order member function checks. Duplicate detection could be useful for sorting rows for hierarchical queries. In instances where there is information stored in a row that requires semantic comparison, such as the example office_type attribute, it is difficult to use hashing for duplicate detection because hash functions in general use all the bytes of a row. For example, hashing a row that includes the office_type attribute would require special hash functions that are aware of the internals of the order member function that was specified for the type.

The approaches described in this section are approaches that could be pursued, but not necessarily approaches that have been previously conceived or pursued. Therefore, unless otherwise indicated, it should not be assumed that any of the approaches described in this section qualify as background merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In order to describe the manner in which advantages and features of the disclosure can be obtained, a description of the disclosure is rendered by reference to specific embodiments thereof, which are illustrated in the appended drawings. These drawings depict only example embodiments of the disclosure and are not, therefore, to be considered to be limiting of its scope. The drawings may have been simplified for clarity and are not necessarily drawn to scale.

FIG. 1 is a block diagram that depicts an example Database Management System (DBMS) according to an example embodiment.

FIG. 2 is an illustration of a multi-vector query on document chunks according to an example embodiment.

FIG. 3 is an illustration of a multi-vector query syntax according to an example embodiment.

FIG. 4 is an illustration of a query using joins with multi-vector grouping according to an example embodiment.

FIG. 5 is an illustration of partitioned row limiting according to an example embodiment.

FIGS. 6A-6G are illustrations of operations of partitioned row limiting according to an example embodiment.

FIG. 7 is an illustration of partitioned row limiting for two partitions according to an example embodiment.

FIG. 8 is an illustration of partitioned row limiting for three partitions according to an example embodiment.

FIGS. 9 and 10 are illustrations of query plans according to example embodiments.

FIG. 11 is a flowchart of a method for partitioned row limiting, according to an example embodiment.

FIG. 12 is an illustration of a partitioned sort according to an example embodiment.

FIG. 13 is an illustration of a partitioned sort with duplicate elimination on non-sort keys according to an example embodiment.

FIG. 14 is a flowchart of a method for a partitioned sort with duplicate elimination on non-sort keys, according to an example embodiment.

FIG. 15 is an illustration of spilling to disk for a partitioned sort with duplicate elimination on non-sort keys according to an example embodiment.

FIG. 16 is an illustration of the results of an operation of spilling to disk according to an example embodiment.

FIG. 17 is a flowchart 1700 of a method for partitioned sorting with duplicate elimination on non-sort keys, according to an example embodiment.

FIG. 18 is a block diagram that illustrates a computer system upon which aspects of the illustrative embodiments may be implemented.

FIG. 19 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Embodiments provide for hierarchical sorting of user data. Multiple sorts are performed, where the results of one sort influence the results of at least one other sort. A first sort determines a full order of primary results. The first sort provides the primary results that are sorted and grouped based on a hierarchical relationship. For example, the first sort can be a primary sort that groups employees by team as a lower level in the hierarchy and by department as a higher level in the hierarchy.

In a possible implementation, the first sort can be a partitioned sort that is a two-level sort that first sorts on the partition key and then, within that partition, sorts on an ordering key. Because the first sort has these two levels, the first sort can more easily keep track of how many rows it has for each partition, allowing the first sort to discard unneeded rows more easily. For example, if the first sort is sorting by organization identifier (orgid) and salary (sal) descending, and only wants two rows per orgid, if the first sort already has two rows for a particular orgid partition, the first sort can throw out any incoming rows for that orgid that have a smaller salary.

In the hierarchical sorting, at least one filtering sort filters the first sort. The filtering sort influences the results of the first sort, such as by identifying which results to return from the first sort. When there are multiple levels of filtering sorts, initial filtering sorts influence subsequent filtering sorts. For example, a second sort after the primary sort determines the top level of the hierarchy, such as by using an ordering key and a unique key. When there is a third filtering sort, the second sort pushes its results as ordering conditions to the third sort. The results of the second sort can include the unique key and the ordering key, which are used as ordering keys along with a different unique key for the third sort. Lower number sorts after the first sort influence the higher number sorts, where a higher number sort can include the unique key and ordering keys from the lower number sort as ordering keys and can add its own unique key. In the higher number sorts, the unique key may factor in unique keys of lower number sorts. For example, when there are teams with the same identifier in different departments, a lower sort unique key may be for the department identifier, and a unique key for the higher sort can be based on unique department and team combinations. The number of sorts depends on the number of hierarchical levels, and the final sort filters the results from the first sort. In some instances, the first sort may not be necessary, and at least one filtering sort may operate on existing sorted and grouped data. In this case, the filtering sort may be considered the first sort.

According to an embodiment, a query is received for data items that have a plurality of attributes that include a first attribute and a second attribute that has a hierarchical relationship with the first attribute. A first sort of the data items is performed based on a first set of ordering keys, including the first attribute and the second attribute. A second sort of the data items is performed based on a second set of one or more ordering keys, the second set being a proper subset of the first set. Based on the results of the second sort, a subset of the results of the first sort is selected. The subset of results can be returned in response to the query.

These embodiments provide an improved syntax for expressing a search based on hierarchical attributes and also provide an improved search technique that both provide more efficient and more accurate operation of a database. For example, embodiments improve database performance by efficiently sorting user data, which saves processing power. Embodiments also save processor power and memory by not requiring the loading of all results and by not requiring post-processing on the results.

Embodiments also provide for partitioned sorting with duplicate elimination on non-sort keys. For example, the filtering sorts can use a partitioned sort with duplicate elimination on non-sort keys.

According to an embodiment, data items, such as rows, records, and other data items, are stored in memory and/or on disk. The data items have a plurality of attributes that have hierarchical relationships with each other. For example, a first attribute can be an organization identifier or an employee, and a second attribute can be a salary of an employee. A query can be received for the stored data items. A first sort, such as a main sort, of the stored data items is performed based on a first set of ordering keys. The first set of ordering keys includes the first attribute and the second attribute. A second sort, such as an auxiliary sort, of the stored data items is performed based on a second set of one or more ordering keys. The second set is a proper subset of the first set and includes the second attribute as an ordering key. A first sorted structure of the second sort of the stored data items is generated. First pointers are inserted into the first sorted structure. The first pointers point to the stored data items. A second sorted structure, such as a partitioned sort with duplicate elimination on non-sort keys data structure, of the second sort of the stored data items is generated. Second pointers are inserted into the second sorted structure. The second pointers point to the stored data items.

In a possible implementation, a particular first attribute of a particular stored data item is compared to first attributes of stored data items pointed to by the second sorted structure. A first determination is made that the particular first attribute matches a first attribute of a stored data item pointed to by the second sorted structure. In response to the first determination, a second determination is made as to whether to insert a first pointer to the particular data item into the first sorted structure. If the first pointer to the particular data item replaces a second pointer to another stored data item in the first sorted structure, then the second pointer is removed from the first sorted structure and removed from the second sorted structure and the first pointer is inserted into the first sorted structure and into the second sorted structure.

Embodiments improve memory usage because both data structures point to the same underlying data, avoiding duplication of data item content. Also, database technology is improved because each data structure is optimized for its corresponding task, which increases database efficiency, such as when performing partitioned row limiting. Thus, partitioned sorting with duplicate elimination on non-sort keys provides benefits of a reduced memory footprint and fewer processor cycles. Without the second sorted structure, all rows must be placed in the first sorted structure for the second sort, all rows must be maintained in the first sorted structure because it is unknown whether all the rows are for the same key, and a duplicate determination has to be made on the key for each row each time a rows is read out for comparison.

### Database Management System

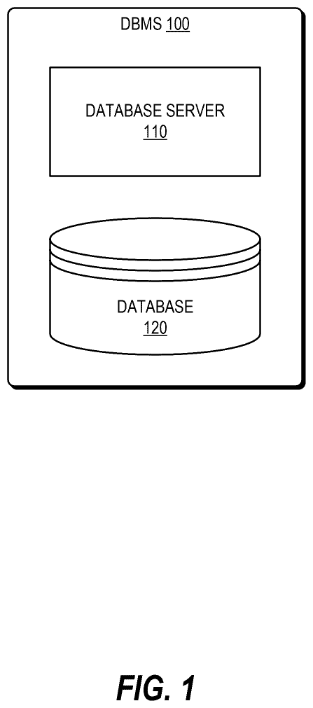

FIG. 1 is a block diagram that depicts an example DBMS 100 according to an example embodiment. DBMS 100 includes a database server 110 and a database 120. The database server 110 is communicatively coupled to the database 120. DBMS 100 may be deployed in a network of an enterprise or may be deployed in a cloud environment and, therefore, may be accessible to an enterprise over one or more computer networks (e.g., the Internet). DBMS 100 may be provisioned for an enterprise by a cloud management team of a cloud provider as needed on an enterprise-by-enterprise basis.

Database server 110 includes one or more computing machines, each executing one or more compute instances that receive and process data requests, including data retrieval requests (e.g., queries) and data modification requests. A computing instance translates a data request into a storage layer request that the computing instance transmits to the database 120. A computing machine that hosts at least one compute instance includes (1) one or more processors, (2) volatile memory for storing data requests (and their respective contents) and data that is retrieved from the database 120, and (3) optionally, non-volatile memory.

The database 120 may comprise multiple storage devices, each storing data. For example, database 120 stores a table that includes one or more columns for storing user data, such as a column for storing a user identifier, a column for storing a user profile, a column for storing user search history, a column for storing user access history, a column for storing user-generated content, etc. In this example, each row in the table corresponds to a user, such as a customer, a subscriber to a service, etc.

### Multi-Vector Queries

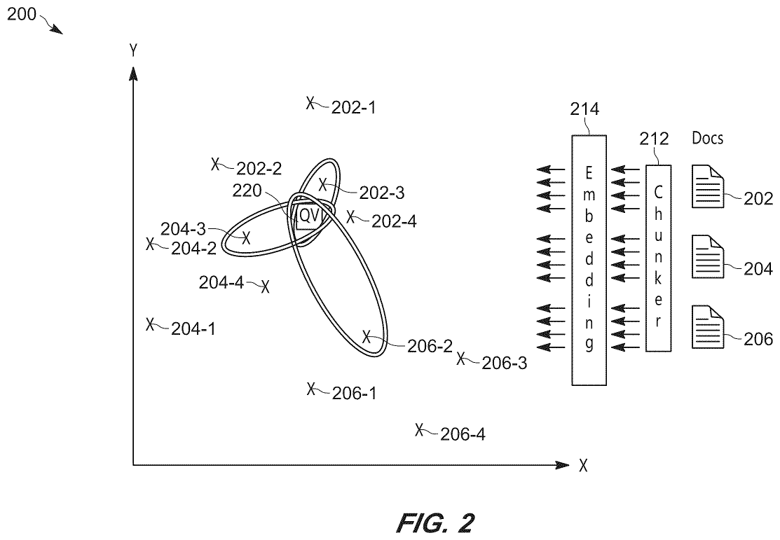

FIG. 2 is an illustration 200 of a multi-vector query on document chunks according to an example embodiment. Documents 202, 204, and 206 are entities that are fed into a chunker 212. The chunker 212 breaks the documents into four chunks each, where each chunk represents a paragraph in this example. An embedder 214 embeds each of the chunks into respective vectors 202-1 through 202-4, 204-1 through 204-4, and 206-1 through 206-4. A user's search term for the documents is embedded in query vector 220. Vectors 202-3, 204-3, and 206-2 are the closest chunk vectors to the query vector 220 across all three documents. The chunk vector 202-4 is closer to the query vector 220 than the chunk vector 206-2, but chunk vector 202-4 is not desired because the user is searching for the top documents, instead of the top paragraphs in this case.

Other examples of entities can be audio recordings, videos, people of interest, and other entities. For example, a person can have multiple photos, such as from surveillance cameras. A person-of-interest search may want a variety of different people instead of a variety of different photos of the same person. Thus, the people should be matched based on their closest matching photo, or a certain limited number of closest photos, for this search.

In a best match search, a document or other entity is ranked higher if the closest chunk it provides is better than the chunks of other documents. For example, one document may have one chunk that is the closest chunk, but the remaining chunks are farther away from a query vector than chunks of other documents. This document can still be ranked higher based on its closest chunk. There are other variations for ranking top documents, such as ranking documents based on average chunk distances across multiple chunks, using weighting functions for mixing chunk distances, using representative scores for the documents, and other variations for ranking documents or other entities.

### Multi-Vector Query Syntax

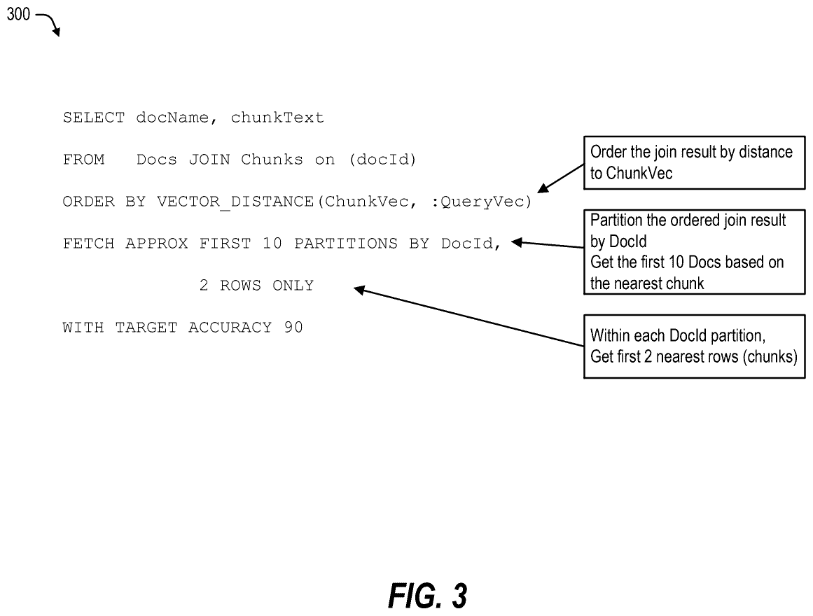

FIG. 3 is an illustration 300 of a multi-vector query syntax according to an example embodiment. In this example, a user desires to find the top 10 documents, docName, containing chunks, such as paragraphs, similar to the query text vector and desires the top two most similar chunks, chunkText, for each document. The documents are joined with the chunks based on a document identifier. The join result is ordered by distance from the chunk vector to the query vector. The ordered join result is partitioned based on the document identifiers. In this application, partitioned means grouped or organized and is not specifically limited to contiguous subsets of rows in a partitioned table. The first 10 documents are fetched based on the nearest chunk. Within each partition of document identifiers, the first two nearest chunks, such as the nearest rows, are fetched. In this example, rows are mentioned along with chunks because the query can also be applied to relational columns, as well as vectors, as will be discussed further below.

The syntax allows a generic hierarchical fetch. The fetch can provide for multiple hierarchical levels. For example, one level in the hierarchy is for paragraphs in a book, and another level in the hierarchy is for books by an author. Such a query can request the five most prolific authors that match a search term, and request two books per author, and two paragraphs within each of the books.

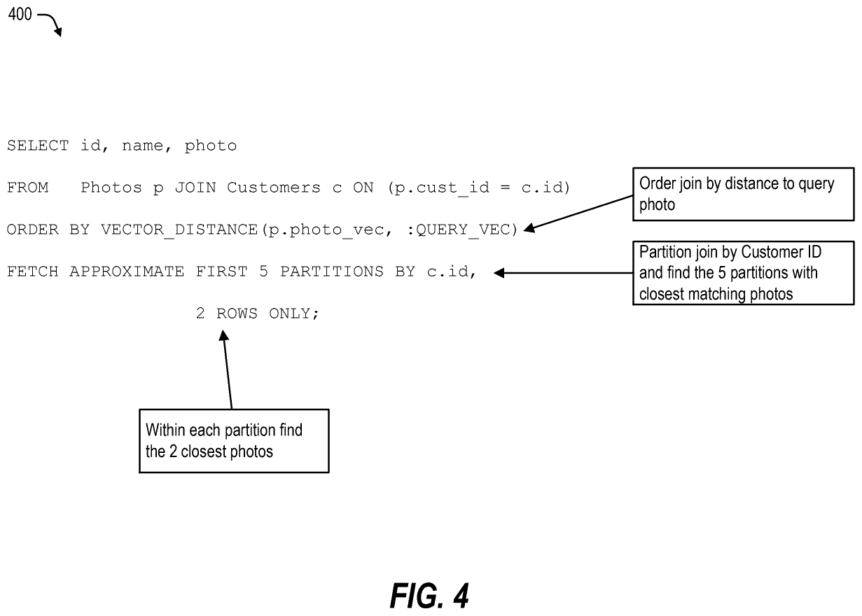

FIG. 4 is an illustration 400 of a query using joins with multi-vector grouping according to an example embodiment. As mentioned above, a multi-vector group by scenario is a scenario in which one entity has multiple vectors. For example, a document may be divided into different chunks, each with a different vector, or a person may have multiple photos, each with a different vector. This example query finds the top five customers and their top two matching photos based on similarity with a search photo. The photos are joined with the customers based on a customer identifier. The join result is ordered by distance from the photo vector to the query photo vector of the search photo. The join is partitioned based on the customer identifier, and the top five customers are fetched based on the partitions with the closest matching photos. Within each partition of customers, the first two nearest photos are fetched. This example shows a desired number of partitions, but other implementations may not limit the number of partitions in order to fetch all partitions.

### Partitioned Row Limiting

The concept of a multi-vector query can also be applied to relational columns, such as relational data, regardless of whether vectors are involved. In particular, partitioned row limiting can be used to partition rows, limit query results to particular partitions and particular rows, and order the results. The following is an example query syntax for partitioned row limiting according to an example embodiment.

```
FETCH FIRST
  [<pbycount1> PARTITION[S] BY <pbyexpr1>
    [, <pbycount2> PARTITION[S] BY <pbyexpr2>]
    [, ...]
    [, <pbycountN> PARTITION[S] BY <pbyexprN>]]
<rowcount> ROW[S] ONLY
```

In this syntax, pbycount is the number of partitions, pbyexpr is the partition by expression, and N is the number of levels in the fetch hierarchy. Partitioned row limiting supports filtering at multiple levels, such as partitions specified using the PARTITION clause. Users can request to limit the number of unique partitions by using <pbycount 1>PARTITION[S] BY <pbyexpr1>, where <pbycount1> is used to specify the number of unique partitions to be returned, and the partition is represented by an expression in <pbyexpr1>.

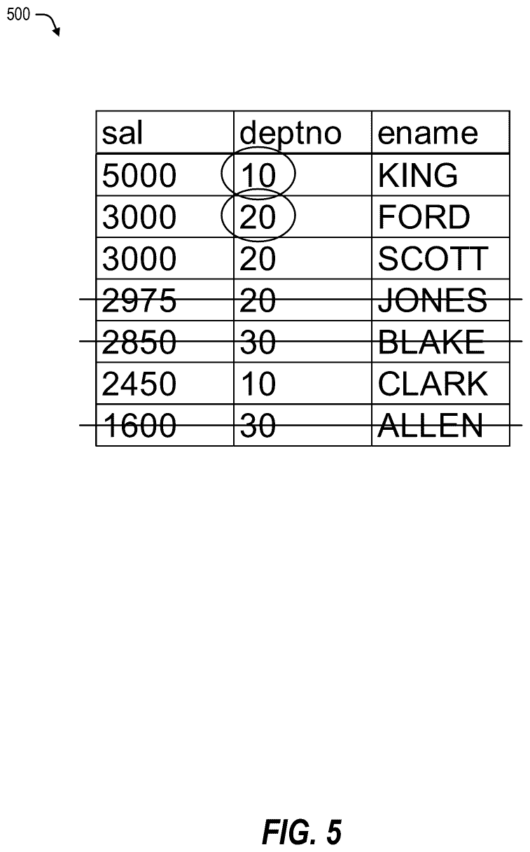

FIG. 5 is an illustration 500 of partitioned row limiting according to an example embodiment. In this example, a user may desire to fetch employees from departments ordered by salary, where the goal is to get the top two departments based on salary, with the top two employees ordered by salary per department. The first level of the hierarchy is to get the departments, and the second level is to get the best salaries per department. The following is an example query using partitioned row limiting for such a search:

| SELECT deptno, ename, sal | |
|---|---|
| FROM emp | |
| ORDER BY sal DESC | |
| FETCH FIRST | 2 PARTITIONS BY deptno, |
| | 2 ROWS ONLY; |

The query selects the department number, the employee name, and the salary from an employee table. It fetches the first two partitions by department number with two rows per partition and orders the results by salary in descending order.

In illustration 500, the best department is department 10 where the employee King has the highest salary of 5000 and Clark has the next highest salary of 2450. The next best department is department 20, where Ford makes 3000 and Scott makes 3000. Blake in department 30 makes 2850, which is more than Clark, but Blake is not returned because the row does not satisfy the first two partitions by department number. The top two department partitions are 10 and 20, and department number 30 is not one of the top two departments. In this case, the top departments are chosen based on the highest salary. In other cases, the top results can be chosen based on average salaries or other scoring concepts.

### Technique for Partitioned Row Limiting

An example technique for partitioned row limiting can use multiple sorts to figure out which partitions to keep. The following is an example query that will be employed to describe the technique:

SELECT ename, orgid, sal
FROM emp
ORDER BY sal DESC
FETCH FIRST 2 PARTITIONS BY orgid, 2 ROWS ONLY;

This example query queries an employee table for the top two organizations by salary and the top two employees in each organization by salary, and orders the results based on the salary column in descending order. In the first operation of the technique, two sorts are used for each input row.

```
Sort 0
      Sort key: orgid [p]
      Sort key: sal DESC
      Payload: ename
Sort 1
      Sort key: sal DESC
      Unique key: orgid
```

The purpose of the first sort, Sort 0, is to dynamically keep track of the top two salaries, sal, for each organization, orgid. The input is sorted in the order of orgid with the order by key, sal. Rows with low salaries may be taken out from the sort on the fly or may not be inserted to sort at all. The partition key is marked with a “[p]”. The purpose of the partition key is to group data that belongs to the same partition together. It can also be used to filter out extra rows, such as to provide only the top two rows for a query for 2 rows only. The two sort keys of Sort 0 can be combined in the same line, as shown in later examples. A payload, such as ename, is included in Sort 0 to return the ename in the results requested by the SELECT clause. The payload can also be combined in the same line as the sort keys. Sort 0 may not include any other requested attributes, such as ename. In such a case, any requested attributes can be joined back with the source data after scanning Sort 0. The first sort, Sort 0, sorts the entire input. Subsequent sorts, such as Sort 1 and other sorts, can sort based on required keys with other attributes removed.

For example, when partitioned, all the employee names are grouped by the organization identifier. The second sort/ordering key, salary, sorts the employees by salary in descending order, which provides for the identification of the top two employees in each organization. All the employees that are not in the top two can be filtered out on the fly. For example, when searching for two rows only, if there are already two employees in an organization and a third employee has a smaller salary, that employee can be tossed from the search. The result of Sort 0 gives all the orgids with at most two employees per orgid.

The purpose of the second sort, Sort 1, is to determine which two orgids should remain. Thus, Sort 1 dynamically determines the top two orgids with the highest salary, sal). In this example for Sort 1, there is only one sort key, the sal in descending order. The unique key, orgid, is remembered when scanning the sort to maintain a number of unique values of that key. The unique key, orgid, may not otherwise be needed for sorting. To remember the unique key, as the rows are read out of the sort 1, each orgid value is put into a separate structure, such as a hash table, to keep track of whether the orgid value is a duplicate of another value or not. According to a possible embodiment, a partitioned sort with duplicate elimination on non-sort keys allows for determining the duplicates as the rows are inserted in the sort instead of when they are read out.

Sort 0 and Sort 1 can be performed in parallel. As the table is scanned, the rows are put into a sort buffer, where Sort 0 is performed on two columns, orgid and sal. Sort 1 is performed on sal because the goal of the two sorts is different. Sort 0 tracks all orgids without regard to which one orgid is better. Sort 0 also keeps the top two salary results per orgid. Sort 1 tracks the two orgids with the best salaries.

In a second operation of the technique, Sort 0 is scanned. Each remaining orgid in Sort 1 is positioned in Sort 0 to produce the rows with the best orgid.

### Partitioned Row Limiting Operations

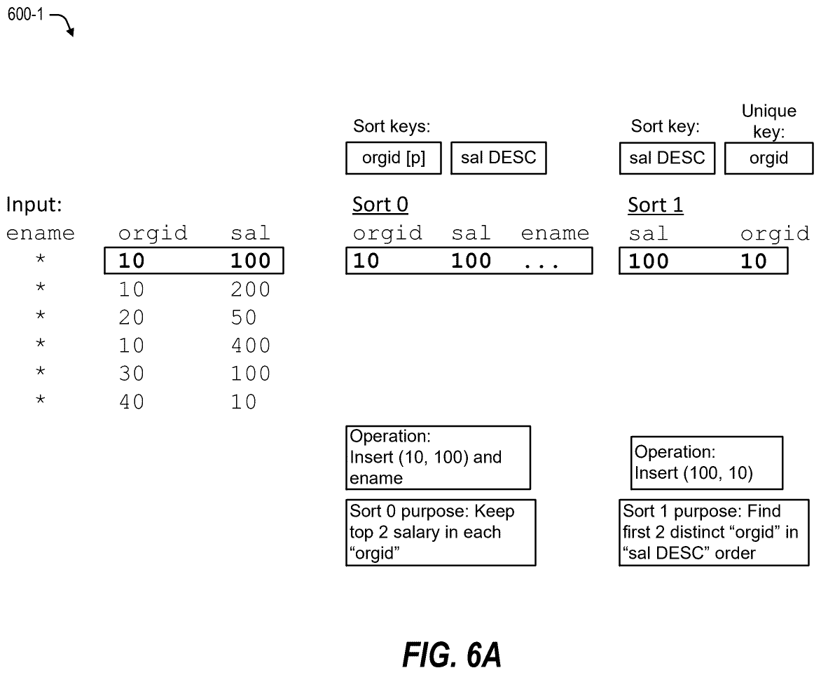

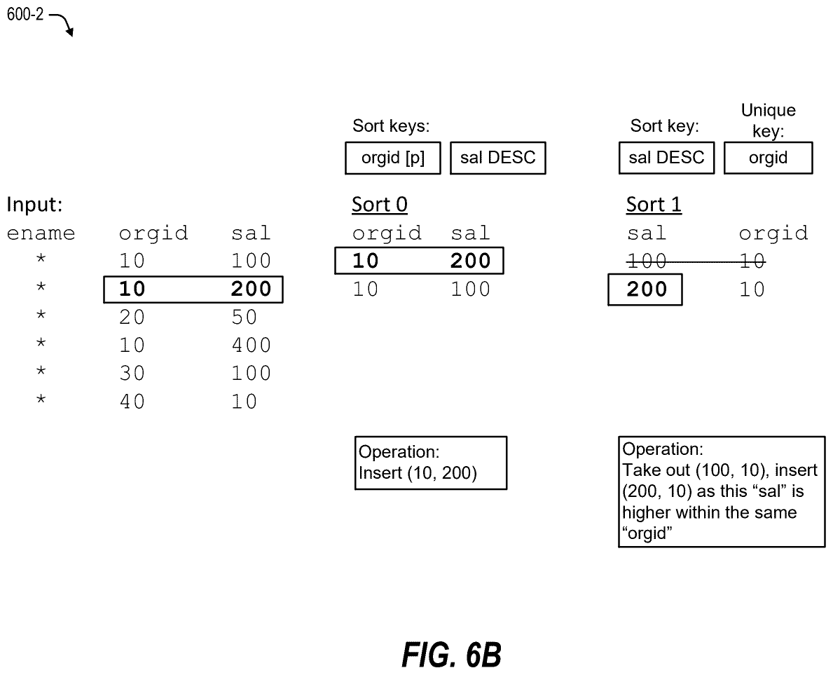

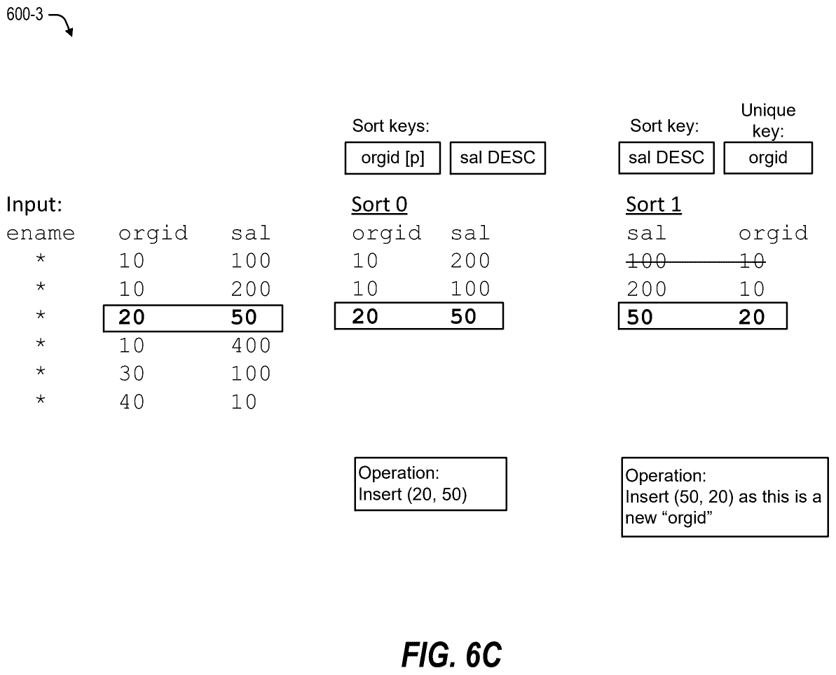

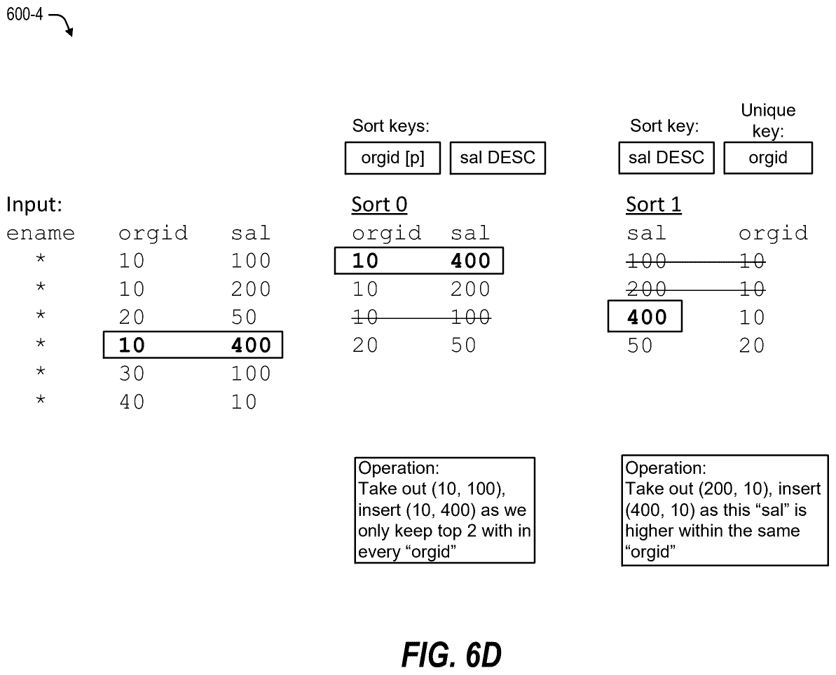

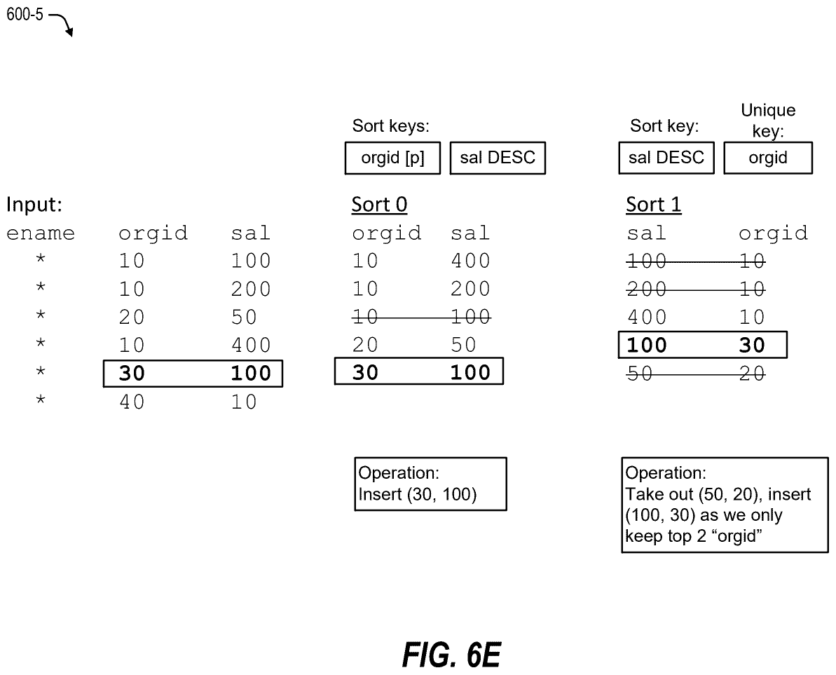

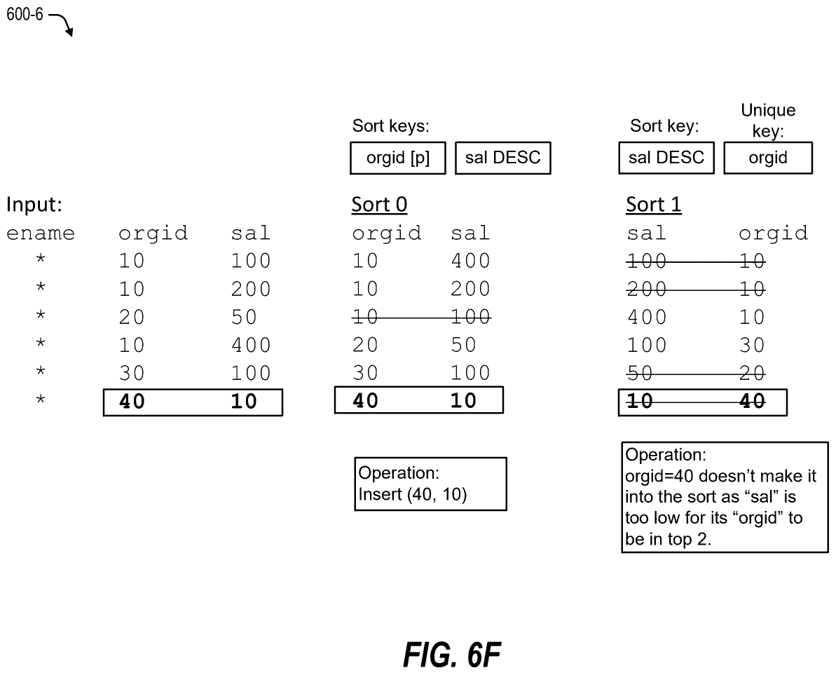

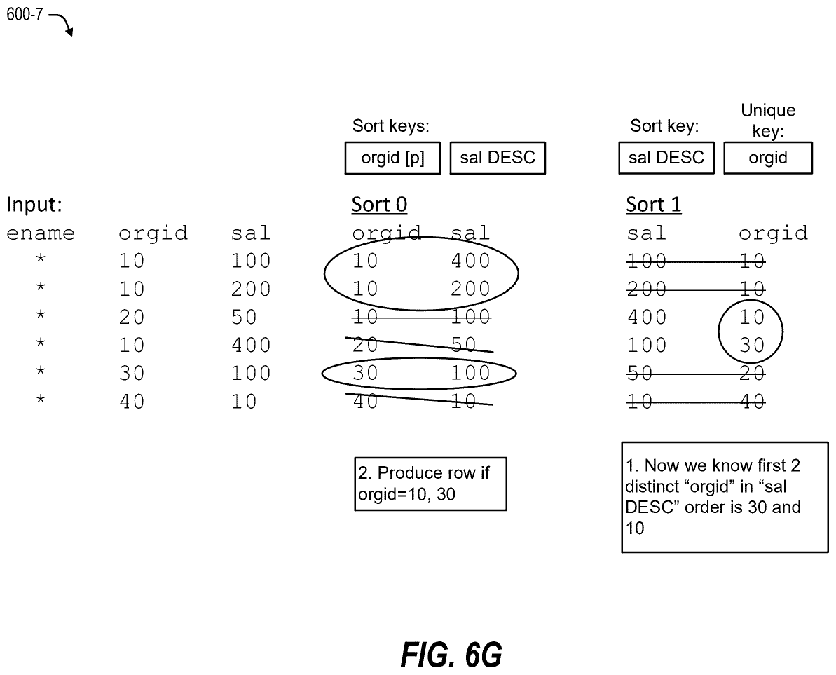

FIGS. 6A-6G are illustrations of operations 600-1 through 600-7 for partitioned row limiting according to an example embodiment. The operations fetch two partitions by orgid with 2 rows only, as described in the query above. The employee names, ename, are omitted from the illustrations for this example.

In operation 600-1, the first row 10, 100, as well as the ename, from the input employee table goes into Sort 0, where sal is a sort key in descending order and orgid is a sort key and the partition key, such as a grouping key. The first row 10, 100 also goes into Sort 1, where sal is a sort key in descending order and orgid is a unique key.

In operation 600-2, the second row 10, 200 is added to Sort 0 and is ranked higher due to the sal of 200. In Sort 1, the 100, 10 row is taken out because the 200 sal is higher than the existing 100 sal with the same orgid and that is the value used to rank the orgids. The ename is not included in this or subsequent operations for simplicity of description.

In operation 600-3, the row 20, 50 is for a new orgid 20 and added to Sort 0. The 20, 50 row is also added to Sort 1.

In operation 600-4, the orgid of 10 in the row 10, 400 already exists in Sort 0 and Sort 1. The row 10, 100 in Sort 0 is taken out because only the top two salaries are desired. In Sort 1, the 200 salary is no longer the best for orgid 10 and the entry is updated with a salary of 400. As a reminder, Sort 1 is keeping track of the best salaries for the top two orgids and Sort 0 is keeping track of the top two salaries of every orgid.

In operation 600-5, the row 30, 100 has a new orgid and is added to Sort 0. Sort 1 only keeps track of the top two orgids, and orgid 20 has a lower salary, 50, than 100 for orgid 30. Thus, the row with orgid 20 is removed and a row for orgid 30 is added with a salary of 100.

In operation 600-6, the row 40, 10 is added to Sort 0 because orgid 40 is new. Row 40, 10 is not added to Sort 1 because the salary of 10 is too low to be in the top two.

In operation 600-7 Sort 0 results in the top two sal per orgid. Sort 1 results in the top two orgid, 10 and 30, ordered by the best sal. The orgids are selected from Sort 1 and the corresponding rows for orgid 10 and 30 are returned from Sort 0, while the rows for orgid 20 and 40 are discarded. There is only one row for orgid 30, but this example is based on “up to” two rows so only one is returned.

Thus, for a query with two levels of hierarchy, one sort, Sort 1, is performing the absolute ordering on the desired partitions/grouping, the ranking of the orgid. The other sort, Sort 0, is tracking the two rows per partition. The results of Sort 1 are used to filter the results of Sort 0. Sort 1 can be modified based on criteria other than the top individual salary. For example, Sort 1 may track orgids with the highest average salary, highest median salary, or any other score.

In some embodiments, the number of partition levels can be zero, which can be considered a non-partitioned row limit. In this case, the results of Sort 0 can be returned without applying Sort 1.

Operations 600-1 through 600-7 show how partitioned row limiting works in a situation where the operations can immediately detect duplicates when putting rows into Sort 1. The detection is possible when Sort 1 uses a partitioned sort with duplicate elimination on non-sort keys. Otherwise, if Sort 1 is a regular sort, it sorts the rows by sal, desc. The orgid unique key is carried along with the sort key. When the second row 10, 200 is put into Sort 1, all Sort 1 would be able to detect is that 200 is a bigger salary than 100, and so the 10, 200 row should be ordered ahead of the 10, 100 row. It would not occur until after all the rows have been put into Sort 1 and Sort 1 starts reading the rows out that Sort 1 can remember the orgid values as it reads the rows out, in order to discard the duplicate rows.

### Two Levels of Partitions Example

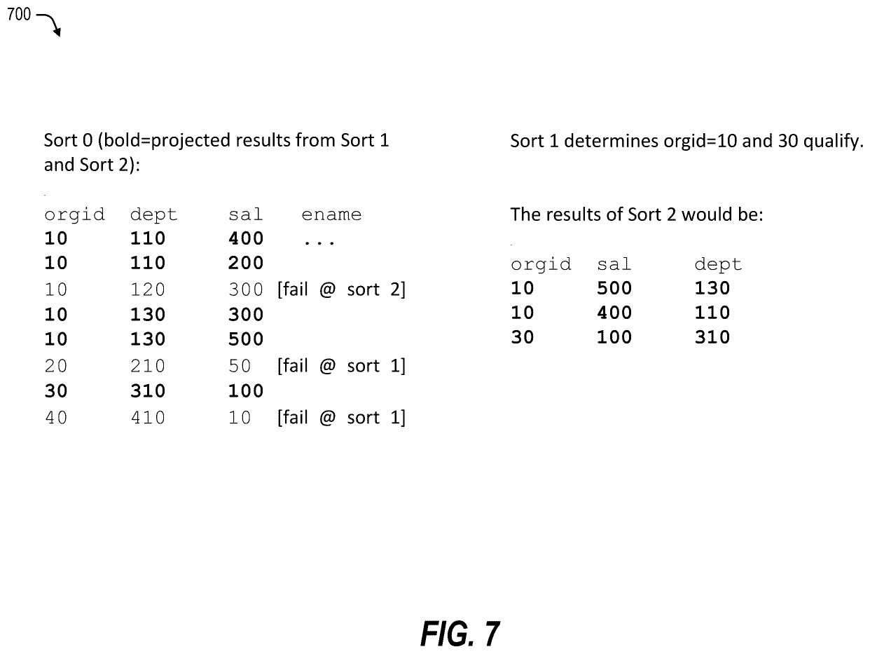

FIG. 7 is an illustration 700 of partitioned row limiting for two partitions according to an example embodiment. The partitioned row limiting technique can be generalized for any number of levels of partitions. The following is an example query building on the query above for two partitions:

SELECT ename, orgid, dept, sal
FROM emp
ORDER BY sal DESC
FETCH FIRST 2 PARTITIONS BY orgid, 2 PARTITIONS BY dept,
2 ROWS
ONLY;

The keys are shown below:

```
Sort 0
      Sort keys: orgid [p], dept[p], sal DESC; Payload: ename
Sort 1
      Sort key: sal DESC
      Unique key: orgid
Sort 2
      Sort keys: orgid [p], sal DESC
      Unique key: dept
```

This example includes one level for the orgid partition and another level for the dept partition. Sort 0 tracks for the full level of the hierarchy for all the partitions with all the partition keys and sort/ordering keys. Sort 0 includes an additional sort and partition key, dept[p] along with sort keys orgid[p] and sal DESC. Sort 0 dynamically keeps track of the top 2 salary rows for each orgid and dept combination. Again, rows with low salaries may be taken out from the sort on the fly or may not be inserted into the sort at all. Sort 0 has the projected results shown in bold in illustration 700. Each subsequent sort level eliminates one of the levels of the hierarchy and finds the order across the remaining results.

Sort 1 finds the top two distinct orgid sorted in sal DESC order. The substance of Sort 1 is omitted in illustration 700 because it is the same as described above with sort key=sal DESC and unique key=orgid. Sort 1 determines that orgid 10 and 30 qualify, as described above.

After Sort 1 completes, each remaining orgid in Sort 1 is positioned into Sort 0. Then, all the rows with the remaining orgids from Sort 1 are read from Sort 0 and inserted into Sort 2. Sort 2 is added to determine the top two distinct departments, dept, in sal DESC order for each orgid selected in Sort 1. Thus, Sort 2 dynamically keeps track of the top two depts. Sort 2 is based on the unique combination of orgid and dept. Sort 2 results in the top two distinct depts being 130 and 110 for orgid 10 and the top distinct dept being 310 for orgid 30, where only one result is available for orgid 30. The results of Sort 2 are in sal DESC order.

After the top at most two depts are determined, the results are positioned in Sort 0 to produce rows with orgid=10 and dept=110 or 130, and rows with orgid=30 and dept=310. Thus, the results of Sort 2 are used to filter the results of Sort 0.

### Three Levels of Partitions Example

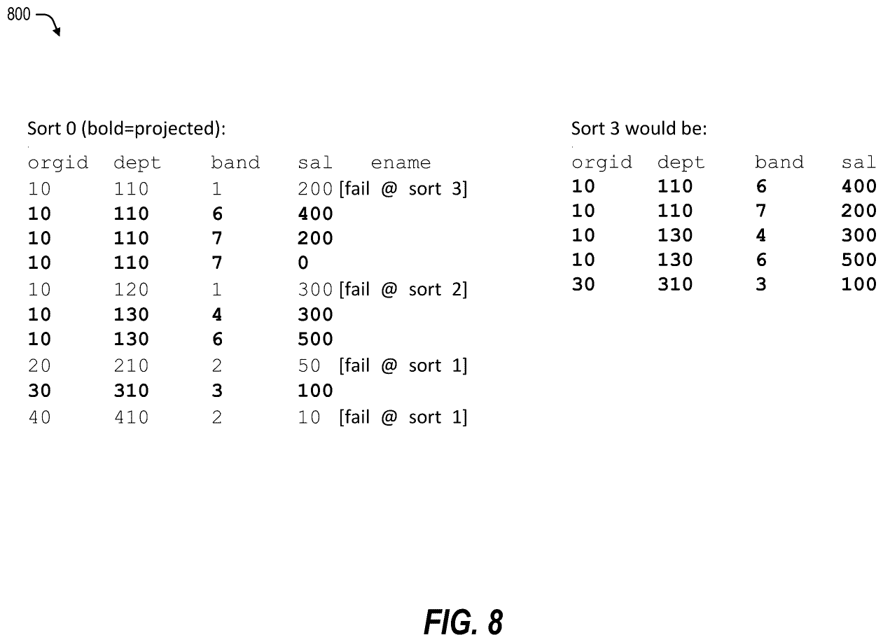

FIG. 8 is an illustration 800 of partitioned row limiting for three partitions according to an example embodiment. Sort 1 and Sort 2 are omitted in the illustration 800 because they are the same as described above. The keys are shown below:

```
Sort 0
      Sort keys: orgid [p], dept[p], band[p], sal DESC; Payload: ename
Sort 1
      Sort key: sal DESC
      Unique key: orgid
Sort 2
      Sort keys: orgid [p], sal DESC
      Unique key: dept
Sort 3
      Sort keys: orgid [p], dept[p], sal DESC
      Unique key: band
```

Sort 0 keeps the top two sal for each orgid, dept, and band combination. Sort 1 finds the top two distinct orgid in sal DESC order. Sort 1 determines that orgid 10 and 30 qualify, as described above. Sort 2 finds the top two distinct dept in sal DESC order for each orgid selected in Sort 1. As describe above, Sort 2 results in the top two distinct depts being 130 and 110 for orgid 10 and the top distinct dept being 310 for orgid 30.

Sort 3 finds the top two distinct band values for each orgid, dept combination selected in Sort 2. Sort 3 is based on the unique combination of band, orgid, and dept. For orgid=10, dept=130, the top two bands=6, 7. For orgid=10, dept=110, the top two bands=4, 6. For orgid=30, dept=310, the top two band(s)=3 (only one available band).

Then Sort 0 is searched to produce orgid=10, dept=110, band=6 and 7, produce orgid=10, dept=130, band=4 and 6, and produce orgid=30, dept=310, band=3. Thus, the results of Sort 3 are used to filter the results of Sort 0. Sort 0 has the projected results shown in bold in illustration 800.

### Multiple Levels of Partitions

The technique can be applied to any number of partitions, such as by using the following syntax:

ORDER BY o₁, o₂, ..., oₘ

| | |
|---|---|
| FETCH FIRST | x₁ PARTITIONS BY p₁, x₂ PARTITIONS BY p₂, ... , |
| | xₙ PARTITIONS BY pₙ, |
| | y ROWS ONLY; |

This is a Top N expression that fetches a certain number of rows x₁ from partitions p₁, another number of rows x₂ from partition p₂, etc., with y number of returned rows per combination. The value of x can be a positive integer. The partition keys, p, can be columns from a table, can be columns from join results of tables, can be from views, can be based on different entities, chunks, etc., such as based on vectors corresponding to an entity, and/or can be any other key. For example, if the algorithm is applied outside of a database, the partition keys can be a column from a spreadsheet, an attribute of objects in an array in programming language, or other keys. The partition keys can also be a metric for a database relation. A metric includes columns, expressions/functions of columns, aggregate functions, analytic functions, or any other metric. A database relation includes tables, views, join results, subqueries, table functions, and/or any other database relation. The number of sorts, such as sort buffers, will be 1+levels of PARTITIONS BY.

Sort 0 determines the top y rows for each partition combination (p₁, p₂, . . . ) with sort keys: p₁ [p], p₂ [p], . . . , pₙ [p], o₁, o₂, . . . , oₘ. Non-keys, such as payloads/other selected operands, can be metrics that are used for future operations.

Sort i, where i can be an integer between 1 and n, determines top xᵢ values for partition combination (p₁, p₂, . . . , pᵢ) with sort keys: p₁ [p], p₂ [p], . . . , pᵢ₋₁ [p], o₁, o₂, . . . , oₘ. There can be no partition keys when i=1. In Sort i, the unique key is pᵢ [p] and there can be no non-key, such as no payload.

The expected cardinality can be <NDV of p1>*<NDV of p2>* . . . *<NDV of pn>*y. This estimates the number of unique combinations where NDV represents the number of distinct values, such as the count of unique values in a column, and y is an adjustment factor.

### Functional Query Plans

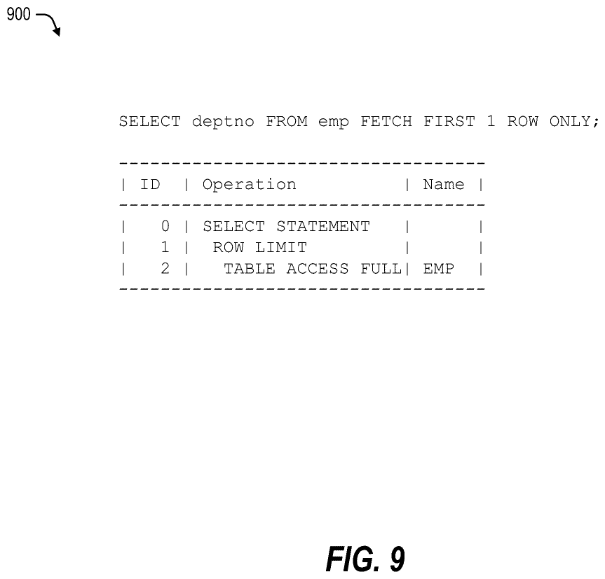

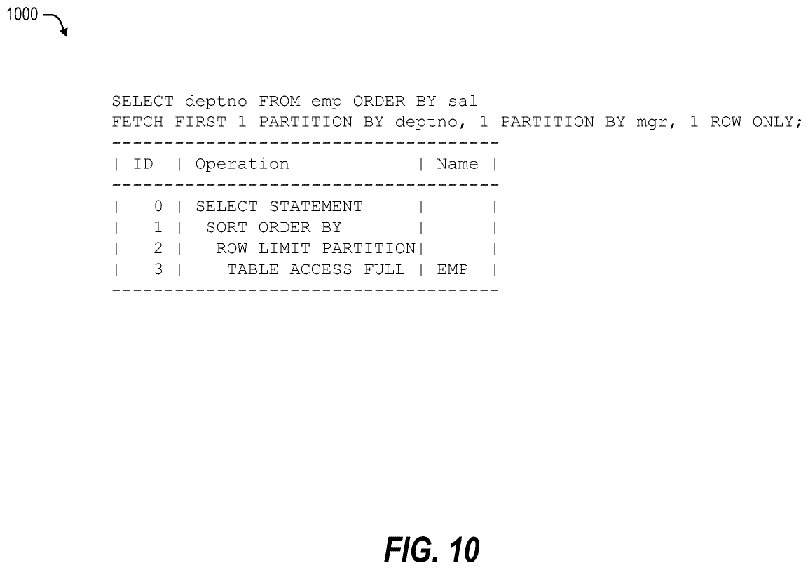

FIGS. 9 and 10 are illustrations of respective query plans 900 and 1000 according to example embodiments. Plans 900 and 1000 can be execution models created by a database server after receiving the SELECT statement. The identifiers, ID, represent different plan nodes, where each row ID corresponds to a function. Each node with an ID, such as each row, in the tables of plans 900 and 1000 is an operation in the SQL query execution. The results of one row are consumed by the function in the row above. A row takes data provided by its child[ren] rows and projects data to its parent row.

A new node, ROW LIMIT PARTITION, can be provided in a query plan. The ROW LIMIT [PARTITION] is the partitioned row limiting technique described above. It takes columns from the table scan of an employee (EMP) table, filters rows with the partitioned row limiting technique, and projects the results to its parent, such as the SELECT STATEMENT in plan 900, or the SORT ORDER BY in plan 1000.

Plan 900 does not include an ORDER BY clause or PARTITION clause in the FETCH FIRST clause. Plan 900 shows the row limit, which limits the number of rows from the table scan. Plan 1000 includes ORDER BY and PARTITION clauses. Plan 1000 includes an ID 3 full table scan, TABLE ACCESS FULL, of an employee table EMP. On top of that is an ID 2 ROW LIMIT PARTITION, for the partitioned row limiting operation. On top of that is an ID 1 SORT ORDER BY to provide the result in the desired order after filtering out the correct rows using partitioned row limiting. In this example, individual results are ordered by the salary instead of being grouped by partition. The ID 0 SELECT STATEMENT pulls rows out of the sort to send as results to the query.

### Example Methods

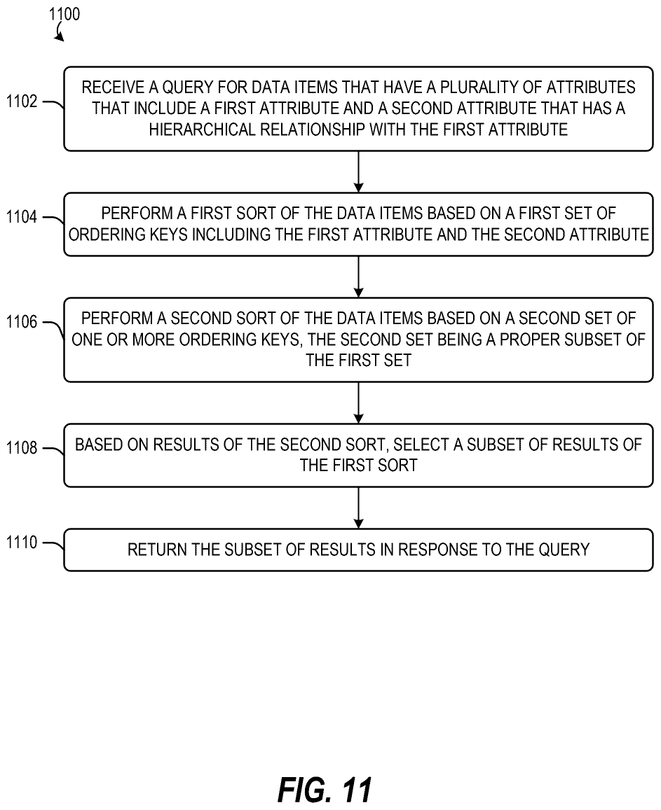

FIG. 11 is a flowchart 1100 of a method for partitioned row limiting, according to an example embodiment. The method can be performed by one or more computing devices.

At 1102, the method includes receiving a query for data items that have a plurality of attributes that include a first attribute and a second attribute. The second attribute has a hierarchical relationship with the first attribute. In the context of the examples described above, the first attribute can be orgid and the second attribute can be sal. In a hierarchical relationship of attributes, there are multiple values of a lower-level attribute for each value of a higher-level attribute. For example, for each value of a first-level attribute, such as orgid, there are multiple values of a second-level attribute, such as sal.

At 1104, the method includes performing a first sort of the data items based on a first set of ordering keys including the first attribute and the second attribute. In the context of the examples described above, the first sort can be Sort 0. At 1106, the method includes performing a second sort of data items based on a second set of one or more ordering keys, the second set being a proper subset of the first set. In the context of the examples described above, the second sort can be Sort 1. The second sort does not need to sort all the data items. For example, it can sort only on the second attribute while keeping the first attribute unique.

At 1108, the method includes, based on results of the second sort, selecting a subset of results of the first sort. In the context of the examples described above, this operation can involve scanning Sort 0. At 1110, the method includes returning the subset of results in response to the query.

According to a possible embodiment, a second sort is based on an attribute lower in a hierarchy. The method can include making a determination that the second attribute, such as sal, is lower in an attribute hierarchy than the first attribute, such as orgid. The method can include, based on the determination, including the second attribute in the second set of one or more ordering keys. The method may not have a particular order. For example, the operation of making of a determination and the operation of including of this embodiment can be performed at any time in the method.

According to a possible embodiment, a query syntax includes a partition key. The query specifies a grouping clause, such as “partition by,” for a partition key based on the first attribute. Performing the first sort includes grouping the data items based on the partition key. In a possible implementation, the query includes an indication of the first attribute as the partition key and an indication of the second attribute. The subset of results is grouped based on the partition key.

According to a possible embodiment, the query specifies a positive integer indicating a number of groups of data items based on the first attribute. For example, the query can specify “2 partitions by orgid.” Performing the second sort includes limiting the number of results of the second sort to the number of groups of data items.

According to a possible embodiment, the first attribute becomes a unique key in a second sort. In particular, performing the second sort includes making a unique key for the results of the second sort based on the first attribute. This is where a partitioned sort with duplicate elimination on non-sort keys can be used. Without the partitioned sort with duplicate elimination on non-sort keys, the duplicate elimination would be done after the second sort has finished ordering the rows, while the rows are read out of the sort, using another structure to keep track of duplicates.

According to a possible embodiment, the query specifies a positive integer indicating a number of data items, such as “2 rows only,” for a particular value of the first attribute. Performing the first sort includes limiting a number of data items for each value of the first attribute to the indicated number of data items.

According to a possible embodiment, the query specifies an order by clause for the second attribute. The order by clause can include a list of attributes. The subset of results are ordered based on the second attribute.

According to a possible embodiment, additional sort levels can be employed. In particular, the plurality of attributes include a third attribute, such as dept, that has a hierarchical relationship with the first attribute. The first set of ordering keys also includes the third attribute. The method includes performing a third sort of the data items based on a third set of ordering keys, the second set being a proper subset of the third set. In the context of an example described above, the third sort can be sort 2. The method includes selecting the subset based on results of the third sort, the subset of results of the first sort. According to a possible implementation, the third sort can also be performed based on the results of the second sort. In particular, performing the second sort includes making a first unique key for the results of the second sort based on the first attribute. Performing the third sort includes making a second unique key for the results of the third sort based on the third attribute.

### Partitioned Sorting

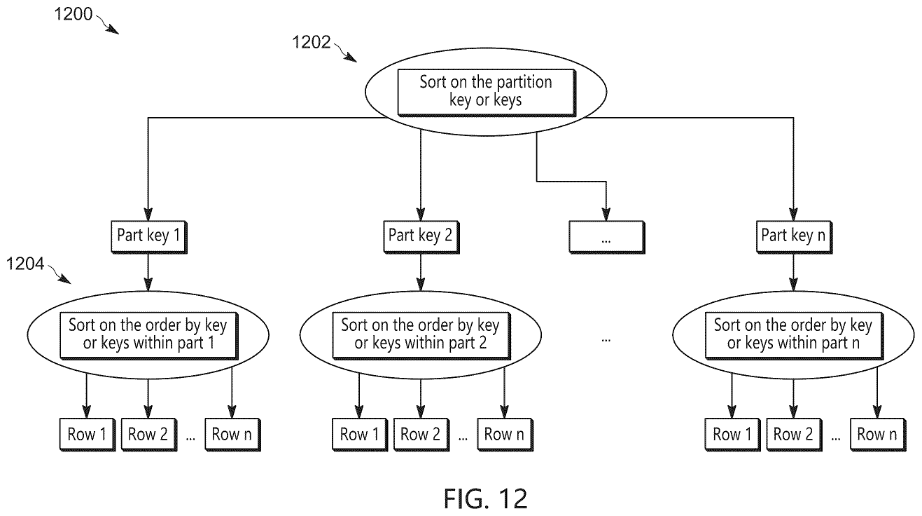

FIG. 12 is an illustration of a partitioned sort 1200 according to an example embodiment. Rows can also be considered data items, records, or other data types. A sort operation of the partitioned sort 1200 can be an in-memory subcomponent of a sort engine or can be any other sort operation. The sort operation can be a two-level sort where the first level 1202 sorts using the partition key or keys, and the second level 1204 sorts the rows within each partition using the ordering keys. For example, when the sort operation receives a row for comparison, the sort operation first sorts on the partition key or keys by searching for rows that have a matching partition key. Then, within the second level for that partition, the sort operation sorts the row using the order by key or keys. The sort operation can use any sorting algorithm, such as insertion sort, that maintains a sorted set as the rows are added to the sort. For example, the sort operation can employ a sort implementation involving an insertion sort with a binary search for position. At any point in time, the rows are sorted and, when a new row is added, a binary search can be performed to determine where to put the row in the sorted set.

For ease of reference for the current embodiments, the following is the example query syntax discussed above for partitioned row limiting:

```
FETCH FIRST
  [<pbycount1> PARTITION[S] BY <pbyexpr1>
    [, <pbycount2> PARTITION[S] BY <pbyexpr2>]
    [, ...]
    [, <pbycountN> PARTITION[S] BY <pbyexprN>]]
<rowcount > ROW[S] ONLY
```

The partitioned row limiting clause uses multiple partitioned sorts. It uses a main sort where the rows are sorted on all the partition-by keys, followed by the order-by keys, if any. It also uses auxiliary sorts that are used to find the top “n” rows for each partition by level. The first auxiliary sort may have no partition-by key, and all the rows are in one partition.

The following is the example query that will be employed to describe the current embodiments:

| SELECT ename, orgid, dept, band, sal | |
|---|---|
| FROM emp | |
| ORDER BY sal DESC | |
| FETCH FIRST | 2 PARTITIONS BY orgid, |
| | 2 PARTITIONS BY dept, |
| | 2 PARTITIONS BY band, |
| | 2 ROWS ONLY; |

For the current embodiments, Sort 0 discussed above will be considered a Main Sort and Sorts 1-3 are considered Auxiliary Sorts. The sorts used and the corresponding sort and unique keys are shown in the table below.

| Sorts used | Sort key(s) | Unique key |
|---|---|---|
| Main sort: For each (“orgid”, “dept”, “band”) | orgid [p] | |
| combination, keep top 2 salary. | dept [p] | |
| | band [p] | |
| | sal DESC | |
| Auxiliary Sort 1: Find out the first two distinct | sal DESC | orgid |
| “orgid” in “sal DESC” order. | | |
| Auxiliary Sort 2: Find out the first two distinct | orgid [p] | dept |
| “dept” in “sal DESC” order for each “orgid” | dept [p] | (and orgid) |
| selected in previous sort. | sal DESC | |
| Auxiliary Sort 3: Find out the first two distinct | orgid [p] | band |
| “band” in “sal DESC” order for each (“orgid”, | sal DESC | (and orgid, |
| “dept”) combination selected in previous sort. | | dept) |

The Main Sort partitions by orgid [p], dept [p], and band [p] and keeps the top two rows based on salary. Thus, the Main Sort can prune out some rows. Auxiliary Sort 1 is used to determine the top two unique orgids, sorted based on descending salary. Auxiliary Sort 2 searches for the top two departments for each orgid. Auxiliary Sort 3 searches for the top two bands for each department for each orgid. The Auxiliary Sorts use partitioned sorting with duplicate elimination on separate non-sort keys.

The following syntax represents the generalized algorithm:

ORDER BY o₁, o₂, ..., oₘ

| | |
|---|---|
| FETCH FIRST | x₁ PARTITIONS BY p₁, x₂ PARTITIONS BY p₂, ... , |
| | xₙ PARTITIONS BY pₙ, |
| | y ROWS ONLY; |

In this case, the number of sorts is 1+n, which is the levels of “PARTITIONS BY.” The Main Sort, Sort 0, determines top y rows for each partition combination (p₁, p₂, . . . , pₙ). The sort keys are p₁ [p], p₂ [p], . . . , pₙ [p], o₁, o₂, . . . , oₘ. The payload (non-key) includes all other selected operands. The Auxiliary Sort i (where i can be an integer between 1 and n) determines the top xᵢ values for partition combination (p₁, p₂, . . . , pᵢ). The sort keys are p₁ [p], p₂ [p], . . . , pᵢ₋₁ [p], o₁, o₂, . . . , oₘ, with no partition keys when i=1. The unique key is: pᵢ [p], and there is no payload (non-key).

### Partitioned Sort with Duplicate Elimination on Non-Sort Keys

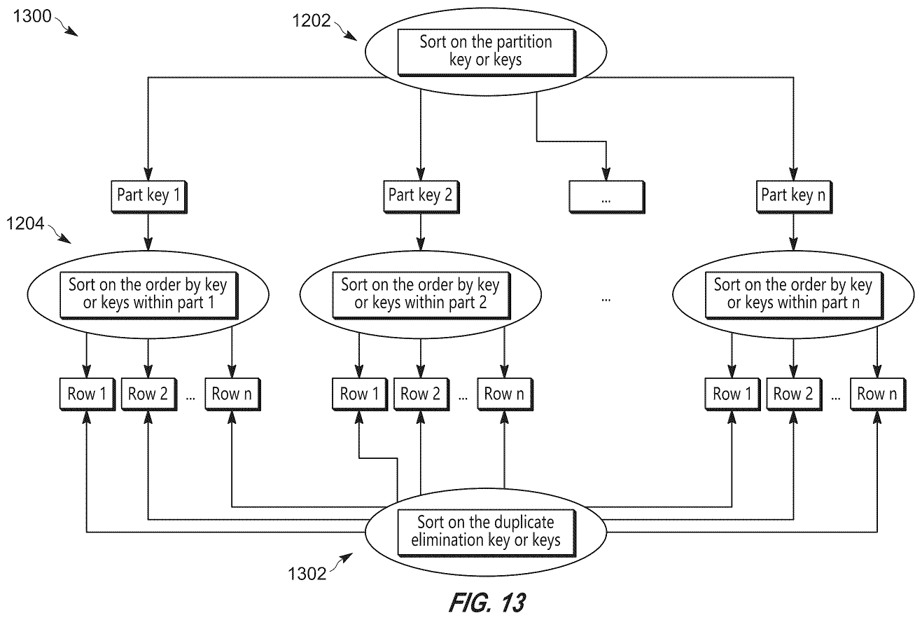

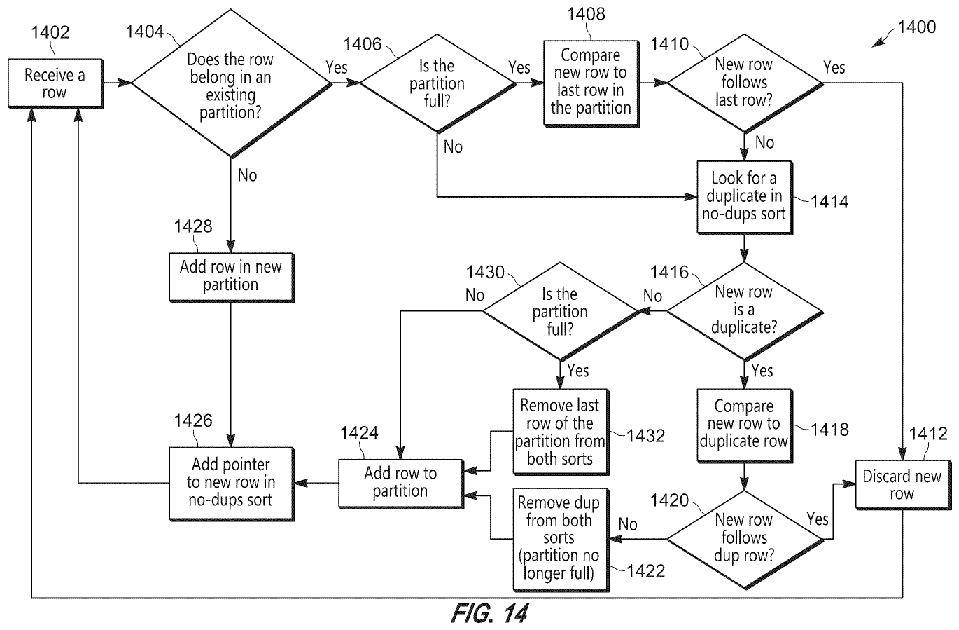

FIG. 13 is an illustration of a partitioned sort with duplicate elimination on non-sort keys 1300 according to an example embodiment. The partitioned sort with duplicate elimination on non-sort keys 1300 includes a duplicate elimination sort 1302 and is used for the Auxiliary Sorts of partitioned row limiting. The duplicate elimination sort 1302 is not a partitioned sort and directly looks at rows. The sorts use two methods to compare the rows. In the first method including the first level 1200 and the second level 1204 of the partitioned sort 1200, only the partitioning and ordering keys are compared, ignoring the unique key. In the second method, the duplicate elimination sort 1302, only the unique key is compared, ignoring the rest of the row. FIG. 14 is a flowchart 1400 of a method for a partitioned sort with duplicate elimination on non-sort keys, according to an example embodiment. At 1402, the method includes receiving a new row. At 1404, the method determines whether the new row belongs in an existing partition, and if so which existing partition, by comparing the partition keys.

If the row goes into an existing partition, at 1406, then the method determines whether the partition is full, such as whether the partition already includes a specified number of rows. If the partition is full, then at 1408, the method compares the new row to the last row in the partition. At 1410, the method determines if the new row follows the last row. If the new row follows the last row, then at 1412, the new row is discarded. If the new row does not follow the last row and thus needs to be inserted into the partition, then at 1414, the method looks for an existing duplicate row in the duplicate elimination sort 1302. For example, the unique key is compared to check if the row is a duplicate of an existing row. At 1416, the method determines whether the new row is a duplicate. If the new row is a duplicate, then at 1418, the new row's ordering keys are compared to the duplicate row's ordering keys to determine which row to keep. At 1420, the method determines whether the new row follows the existing duplicate row. If the new row follows the duplicate row, then at 1412, the new row is discarded. If the new row does not follow the duplicate row, then at 1422, the method removes the duplicate row from the sorts 1200 and 1302, which results in the current partition no longer being full. At 1424, the method adds, that is inserts, the new row to the partition in the partitioned sort 1200. At 1426, the method adds the new row to the duplicate elimination sort 1302.

If, at 1404, the method determines the new row does not belong to an existing partition, then at 1428, the method adds the new row into a new partition for the partitioned sort 1200 and at 1426, the method adds a pointer to the new row to the duplicate elimination sort 1302.

If at 1416, the method determines the new row is not a duplicate, then at 1430, the method determines whether the partition is full. If the partition is not full, then at 1424, the method adds the row to the partition of the partitioned sort 1200. If the partition is full, then, (1) at 1432, the method removes the last row of the partition from both sorts 1200 and 1302, (2) at 1424, the method adds the new row to the partition of the partitioned sort 1200, and (3) at 1426, the method adds the new row to the duplicate elimination sort 1302.

The following example is based on the example query above for ename, orgid, dept, band, sal, sorting by salary descending, at the top level of Auxiliary Sort 1, which uses only one partition. Auxiliary Sort 1 finds the first 2 distinct orgids in sal DESC order, sorting on sal, but orgid is the duplicate elimination key.

The first received row 1 includes orgid: 10 and sal: 5000, and row 1 is added.

The next received row 2 includes orgid: 20 and sal: 3000. A check is performed using the duplicate elimination sort 1302 to determine whether it has a duplicate orgid. Row 2 does not have a duplicate orgid of the orgid of row 1 and row 2 is added.

The next received row 3 includes orgid: 10 and sal: 4000. The new row 3 with sal value=4000 is larger than the row 2 with sal value=3000, so the new row 3 would normally be added to the sort, and the row 2 with sal=3000 would be discarded. However, a duplicate check is performed using the duplicate elimination sort 1302 to determine whether the new row 3 is a duplicate. It is a duplicate because there is already a row with orgid=10, so the ordering keys are compared to check if the first row with sal=5000 or the new row with sal=4000 should be kept for orgid=10. The first row 1 with sal=5000 is kept because 5000 is larger than 4000, and the new row 3 with sal=4000 is discarded and not inserted into the sort.

### Rows on Disk

In a possible implementation, if there is not enough memory to hold all of the rows that need to be sorted, the partitioned sort sorts the rows in batches. Once the sort has used all the memory that is available, the sort writes the rows out to disk, sorted by the partition keys and ordering keys. The sort also creates a temporary index that allows the sort to find a row on disk based on the value of the partition key and order key of the row. Once the sort finishes storing the rows on disk, the sort can free the memory and work on the next batch of rows. However, now the sort has to make sure there are no duplicates either among the in-memory rows or the on-disk rows. The sort uses a temporary index to look for duplicates on the on-disk rows. If a new row has to replace a row that is on-disk, instead of updating the on-disk rows, the sort uses another temporary index to keep track of the rows on disk that were removed. When the sort runs out of memory again, the sort merges the in-memory rows with the on-disk rows, writing out the merged set of rows to disk. The old set of rows on disk can be discarded after the new one is stored.

### Spilling to Disk

In a possible implementation, when spilling rows to disk, only one sorted set of rows may be on disk at a given time. When inserting rows in memory, duplicate rows in the set of rows on disk are checked along with the in-memory rows. To check for duplicate rows on disk, a temporary index is created for the rows on disk. The duplicate elimination key, such as the unique key, can be used as the key for the temporary index if no semantic comparison is needed. Alternatively, if semantic comparison is required, the row number can be used as the key for the temporary index, where the row number is assigned to the rows as they are sorted on the duplicate elimination key, such as in the duplicate elimination sort 1302.

When a new row is inserted, if there is a duplicate of the inserted row on disk, and the duplicate row should be removed, a reference to the removed row is added to a temporary index used to keep track of removed rows. The position of the removed rows is used as the key in the removed row temporary index. For example, a position of the row can refer to a block number and an offset, such as a position of block 10 with an offset of 50.

When memory fills up again and a new set of rows is spilled to disk, the new set of rows is merged with the existing set of rows on disk. If semantic comparison is needed, the rows are first merged using the duplicate elimination key to generate the new row numbers. For example, the rows are merged using the duplicate elimination sort 1302 and the temporary index to determine the new sequence of rows. When the set of rows is written, the row numbers with the row positions are put into the temporary index. Rows that are in the temporary index of removed rows are ignored when spilling a new set of rows or checking for duplicates. For example, when checking for duplicates or merging rows, the index is checked to determine whether the row was removed and can be ignored.

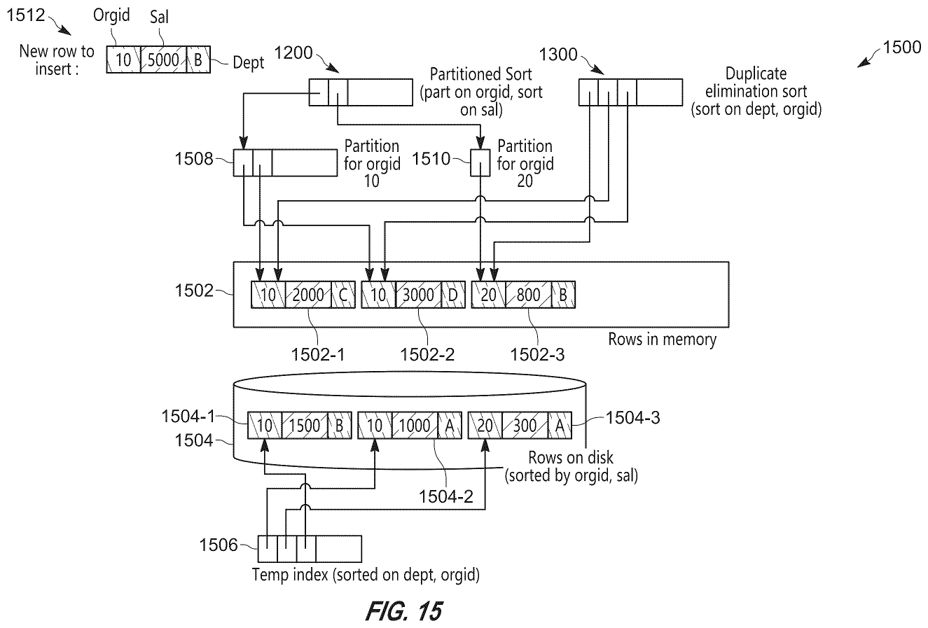

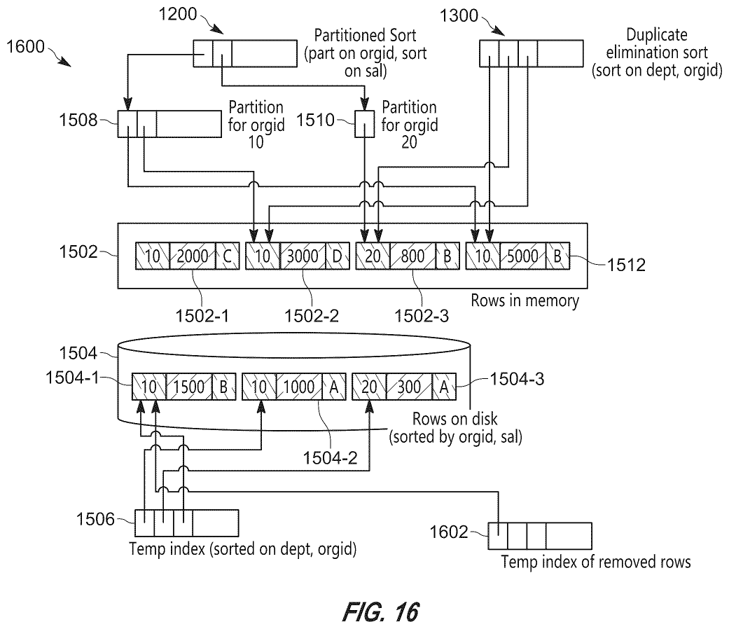

FIG. 15 is an illustration 1500 of spilling to disk for a partitioned sort with duplicate elimination on non-sort keys according to an example embodiment. FIG. 16 is an illustration 1600 of the results of the operation from the illustration 1500 according to an example embodiment. The spilling to disk example uses the above query for SELECT ename, orgid, dept, band, sal, which is repeated here for ease of reference:

SELECT ename, orgid, dept, band, sal
FROM emp
ORDER BY sal DESC

| | | |
|---|---|---|
| FETCH FIRST | 2 PARTITIONS BY orgid, | 2 PARTITIONS BY dept, |
| | 2 PARTITIONS BY band, | 2 ROWS ONLY; |

The illustration 1500 includes a portion of the partitioned sort 1200, a portion of the duplicate elimination sort 1302, rows in memory 1502, rows in set of rows on disk 1504 sorted by (orgid, sal), and a temporary index 1506 sorted on (dept, orgid).

In this example, assume that Auxiliary Sort 1 has already found that the top two orgid values are 10 and 20. Auxiliary Sort 2 will find the first two distinct dept in each orgid in “sal DESC” order with the partition key being orgid and the sort key being sal, but the duplicate elimination key is the combination of dept and orgid. The row format is |orgid|sal|dept|. Orgid and sal are the order by keys, the keys for the main sort that is partitioned by orgid and sorted descending. Dept combined with orgid is the unique key. The partitioned sort 1200 includes two partitions, one orgid 10 partition 1508 and one orgid 20 partition 1510. The orgid 10 partition includes row 1502-1 with (orgid 10, sal 2000, dept C), referred to as “(10, 2000, C)” and row 1502-2 with (10, 3000, D). The orgid 20 partition includes row 1502-3 with (20, 800, B). The sorts 1200 and 1302 can be described as including rows, which may indicate the sorts include pointers to the rows. The set of rows on disk 1504 has three rows from a previous spill to disk. The duplicate elimination sort 1302 also includes the three rows 1502-1, 1502-3. The rows in the duplicate elimination sort 1302 are sorted by department, where the first pointer points to the row 1502-3 that includes department B, the second pointer points to the row 1502-1 that includes department C, and the third pointer points to the row 1502-3 that includes department D. The rows in the partitioned sort 1200 are sorted first by orgid and then by sal. For example, the first pointer points to row 1502-2 with orgid 10 and sal 3000 and the second pointer points to row 1502-1 with orgid 10 and sal 2000. It is noted that the pointers in the illustration 1500 are intended to point to entire rows and not just to individual values in the rows. The three rows in the set of rows on disk 1504 include row 1504-1 (10, 1500, B), row 1504-2 (10, 1000, A), and row 1504-3 (20, 300, A).

In operation, a new row 1512 is received for potential insertion into the sort. The new row 1512 has fields including orgid: 10, sal: 5000, and dept: B (10, 5000, B). There are currently two rows: row 1502-1 (10, 2000, C) and row 1502-2 (10, 3000, D) for in the orgid 10 partition 1508. The sal value 5000 of the new row 1512 is greater than 2000 in the last row 1502-2 in the partition for orgid 10. The duplicate elimination sort 1302 is checked for duplicates, and no duplicates are found for orgid 10 and dept B. The temporary index 1506 is checked for duplicates on disk, and an orgid 10/dept B duplicate is found in row 1504-1 (10, 1500, B). The two sal values 5000 and 1500 are then compared. Because the salary in the new row 1512 is larger, the existing row 1504-1 should be replaced.

In the illustration 1600 of the results, a pointer to the removed row 1504-1 (10, 1500, B) is added to a removed row temporary index 1602. Pointers to the row 1502-1 (10, 2000, C) have been removed from both in-memory sorts 1200 and 1302. Pointers to the new row 1512 (10, 5000, B) are added to the two in-memory sorts 1200 and 1302, where the new row is the first row in the orgid 10 partition 1508 of the partitioned sort 1200, and the new row is also the first row in the duplicate elimination sort 1302. It is noted that details in the illustrations 1500 and 1600 are simplified and may sacrifice accuracy for brevity because the illustration 1500 is based on the memory being full, so the rows in memory and on disk in the illustration 1600 may be different after the new row 1512 is added. It is also noted that pointers can include block values and offset values to point to rows in memory or on disk. For example, a pointer can indicate block 60, offset 20.

Without the duplicate elimination sort 1302, all rows must be placed in the auxiliary sort, such as the partitioned sort 1200, and must be maintained in the auxiliary sort because it is unknown whether all the rows are for the same key, such as for the same orgid. A determination then has to be made on the orgid for each row each time the rows are read out for comparison. An implementation could use a hash table as a structure to determine duplicates. However, a hash table cannot readily handle semantic comparison, and a separate sort would be needed for the semantic comparison. The separate sort would result in the population of two sorts at the same time.

The above query for SELECT ename, orgid, dept, band, and sal, rewritten using window functions illustrates another way to do everything that the partitioned row limit would do. The following table shows the window function-based rewrite, which shows the complexity of the query without partitioned row limiting and without partitioned sort with duplicate elimination on non-sort keys:

```
select ename, orgid, dept, band, sal
  from (select ename, orgid, dept, band, sal, maxsalband,
      row_number( ) over (partition by orgid, dept, band order
      by sal desc) dr4
    from (select ename, orgid, dept, band, sal, maxsalband,
        dense_rank( ) over (partition by orgid, dept order by
        maxsalband desc) dr3
      from (select ename, orgid, dept, band, sal, max(sal)
          over (partition by orgid, dept, band) maxsalband
        from (select ename, orgid, dept, band, sal,
            dense_rank( ) over (partition by orgid order by
            maxsaldept desc) dr2
          from (select ename, orgid, dept, band, sal,
              max(sal) over (partition by orgid, dept)
              maxsaldept
            from (select ename, orgid, dept, band, sal,
                dense_rank( ) over (order by maxsalorgid
                desc) dr1
              from (select ename, orgid, dept, band, sal,
                  max(sal) over (partition by orgid)
                  maxsalorgid
                from emp))
            where dr1 <= 2))
        where dr2 <= 2))
    where dr3 <= 2)
where dr4 <= 2 order by sal desc;
```

The partitioned sort with duplicate elimination on non-sort keys 1300 solves the above-identified issues by providing for efficient row comparison and removal during the sorting process, which saves memory, reduces the number of comparisons, reduces processor activity, and increases sorting speed, which improves database operation.

### Example Methods

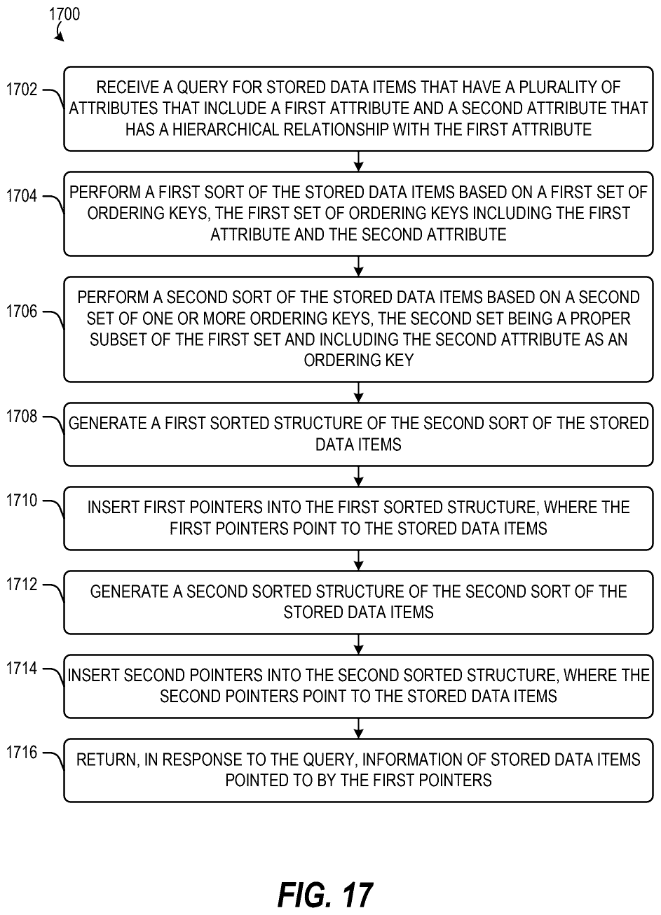

FIG. 17 is a flowchart 1700 of a method for partitioned sorting with duplicate elimination on non-sort keys, according to an example embodiment. One or more computing devices can perform the method. At 1702, the method includes receiving a query for stored data items that have a plurality of attributes that include a first attribute, such as orgid, as a partition key, and a second attribute, such as sal, that has a hierarchical relationship with the first attribute. The data items can be rows, records, and/or other data items.

At 1704, the method includes performing a first sort, such as the Main Sort, of the stored data items based on a first set of ordering keys. The first set of ordering keys includes the first attribute, such as orgid, and the second attribute, such as sal. At 1706, the method includes performing a second sort, such as an Auxiliary Sort, of the stored data items based on a second set of one or more ordering keys. The second set is a proper subset of the first set and includes the second attribute, such as sal, as an ordering key.

At 1708, the method includes generating a first sorted structure of the second sort of the stored data items. At 1710. the method includes inserting first pointers into the first sorted structure, where the first pointers point to the stored data items. At 1712, the method includes generating a second sorted structure, such as the duplicate elimination sort 1302, of the second sort of the stored data items. At 1714, the method includes inserting second pointers into the second sorted structure, where the second pointers point to the stored data items. The second pointers can point to the same data items as the first pointers. At 1716, according to a possible embodiment, the method can include returning, in response to the query, information of stored data items pointed to by the first pointers.

According to a possible embodiment, the first sorted structure is a hierarchical structure including nodes with the first pointers sorted based on the second attribute, such as sal. Each node includes at least one pointer to a stored data item. According to a possible implementation, each node of the first sorted structure corresponds to a first attribute value and contains at least one pointer to a unique data item including the first attribute. The unique data item is unique compared to other data items pointed to by other nodes. At least one node of the first sorted structure contains a plurality of pointers, each of the plurality of pointers pointing to a respective data item, where each data item pointed to by a pointer of the at least one node is unique compared to other data items pointed to by a pointer of the at least one node. According to a possible embodiment, the second sorted structure is a hierarchical structure including nodes with the second pointers sorted based on the first attribute, such as orgid.

### Algorithm

According to a possible embodiment, the method includes comparing a particular first attribute of a particular stored data item to first attributes of stored data items pointed to by the second sorted structure. The method includes determining that the particular first attribute matches a first attribute of a stored data item pointed to by the second sorted structure. The method includes determining, in response to determining that the particular first attribute matches the first attribute of the stored data item pointed to by the second sorted structure, whether to insert a pointer to the particular data item into the first sorted structure.

According to a possible implementation of the above embodiment, determining whether to insert the pointer to the particular data item into the first sorted structure comprises determining that the pointer to the particular data item replaces a pointer to another stored data item in the first sorted structure; and in response to determining that the pointer to the particular data item replaces the pointer to the other stored data item in the first sorted structure: removing the pointer to the other stored data item from the first sorted structure and from the second sorted structure; and inserting the pointer to the particular data item into the first sorted structure and into the second sorted structure.

According to a possible implementation of the above embodiment, data items can be spilled to disk, and an index can be created for the items on disk. For example, the method includes determining that there is insufficient memory to store the data items. The method includes spilling data items to disk in on-disk data item sorted sets of rows in response to determining that there is insufficient memory. The sorted sets of rows are sorted based on the second attribute. The method includes building a data item index for on-disk data items. The data item index for on-disk data items is sorted based on the first attribute. The method includes comparing the particular first attribute to first attributes in the data item index. The method includes determining that the particular first attribute matches a first attribute in the data item index. The method includes determining, in response to determining that the particular first attribute matches the first attribute in the data item index, whether to insert the pointer to the particular data item into the first sorted structure. For example, data items that do not fit in memory are sorted and spilled to disk. The data items are sequentially sorted based on the second attribute, such as sal, and spilled to disk. The data item index is built on disk sorted by the first attribute, such as orgid. The data item index is used to check for duplicates on disk.

According to a possible example of the above implementation, the method includes determining that a new row replaces an existing row identified in the data item index. The method includes, in response to determining that the new row replaces the existing row, adding, to a removed row index, a removed row identifier of the existing row identified in the data item index. The method includes ignoring, based on the removed row identifier in the removed row index, an identifier of the removed row in the data item index during comparing the particular first attribute to first attributes in the data item index. For example, a removed row index is built, and the removed rows identified in the removed row index are ignored when checking for duplicates of data items on disk.

According to a possible implementation of the above embodiments, the plurality of attributes includes a third attribute, such as dept. The data items stored to disk are sequentially sorted based on the first attribute and the second attribute, such based on as orgid and sal. The data item index is sorted based on the third attribute and the first attribute, such as dept and orgid. In another possible implementation of the above embodiment, a key of the data item index is sorted on at least the first attribute, such as a key for the duplicate elimination sort 1302, or a row number assigned from the second sorted structure, such as for the duplicate elimination sort 1302, for semantic comparison.

According to a possible embodiment, sorted structures can be generated for additional Auxiliary Sorts, such as Auxiliary Sort 2, Auxiliary Sort 3, and further Auxiliary Sorts. For example, the plurality of attributes includes a third attribute, such as dept. The method includes performing a third sort, such as Auxiliary Sort 2, of the stored data items based on a third set of one or more ordering keys. The third set includes the first attribute, such as orgid, and the second attribute, such as sal, as ordering keys. The method includes generating a third sorted structure of the third sort of the stored data items. The third sorted structure is a hierarchical structure including nodes that are grouped by the first attribute, such as orgid as a partition key, and sorted based on the second attribute, such as sal. The method includes inserting third pointers into the third sorted structure. The third pointers point to the stored data items. The method includes generating a fourth sorted structure, such as for the duplicate elimination sort 1302, of the third sort of the stored data items. The fourth sorted structure is a hierarchical structure including nodes that are sorted based on the third attribute, such as dept, and the first attribute, such as orgid. The method includes inserting fourth pointers into the fourth sorted structure. The fourth pointers point to the stored data items. The fourth pointers can point to the same data items as the third pointers.

Operations of the described methods can be performed at different times. For example, in some instances, a determination operation can be performed that results in certain method operations based on a certain result of the determination. In other instances, the same determination operation can be performed, which results in different method operations based on a different result of the determination.

### DBMS Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically-marked data objects; however, the hierarchically-marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snapshot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e. .java file) and the compiled version of the class (i.e. .class file).

Native data types are data types supported by a DBMS “out-of-the-box”. Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

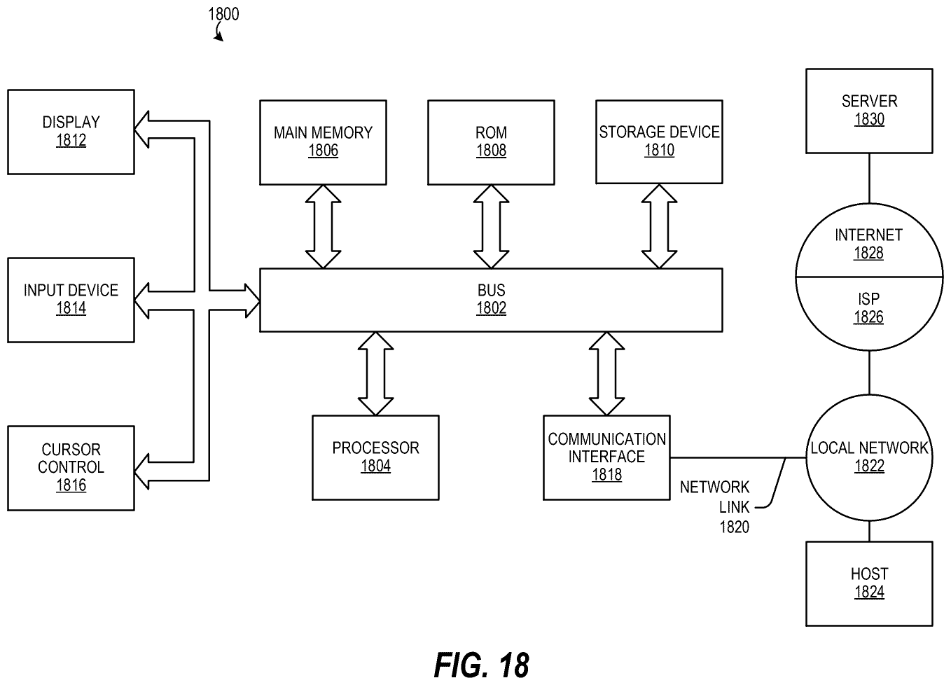

For example, FIG. 18 is a block diagram that illustrates a computer system 1800 upon which aspects of the illustrative embodiments may be implemented. Computer system 1800 includes a bus 1802 or other communication mechanism for communicating information, and a hardware processor 1804 coupled with bus 1802 for processing information. Hardware processor 1804 may be, for example, a general-purpose microprocessor.

Computer system 1800 also includes a main memory 1806, such as a random-access memory (RAM) or other dynamic storage device, coupled to bus 1802 for storing information and instructions to be executed by processor 1804. Main memory 1806 also may be used for storing temporary variables or other intermediate information during execution of instructions to be executed by processor 1804. Such instructions, when stored in non-transitory storage media accessible to processor 1804, render computer system 1800 into a special-purpose machine that is customized to perform the operations specified in the instructions.

Computer system 1800 further includes a read only memory (ROM) 1808 or other static storage device coupled to bus 1802 for storing static information and instructions for processor 1804. A storage device 1810, such as a magnetic disk, optical disk, or solid-state drive is provided and coupled to bus 1802 for storing information and instructions.

Computer system 1800 may be coupled via bus 1802 to a display 1812 for displaying information to a computer user. An input device 1814, including alphanumeric and other keys, is coupled to bus 1802 for communicating information and command selections to processor 1804. Another type of user input device is cursor control 1816, such as a mouse, a trackball, a touch screen, a track pad, and/or cursor direction keys for communicating direction information and command selections to processor 1804 and for controlling cursor movement on display 1812. This input device typically has two degrees of freedom in two axes, a first axis (e.g., x) and a second axis (e.g., y), that allows the device to specify positions in a plane.

Computer system 1800 may implement the techniques described herein using customized hard-wired logic, one or more ASICs or FPGAs, firmware and/or program logic which in combination with the computer system causes or programs computer system 1800 to be a special-purpose machine. According to one embodiment, the techniques herein are performed by computer system 1800 in response to processor 1804 executing one or more sequences of one or more instructions contained in main memory 1806. Such instructions may be read into main memory 1806 from another storage medium, such as storage device 1810. Execution of the sequences of instructions contained in main memory 1806 causes processor 1804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1810. Volatile media includes dynamic memory, such as main memory 1806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and/or any other storage media.

Storage media is distinct from but may be used in conjunction with transmission media. Transmission media participates in transferring information between storage media. For example, transmission media includes coaxial cables, copper wire and fiber optics, including the wires that comprise bus 1802. Transmission media can also take the form of acoustic or light waves, such as those generated during radio-wave and infra-red data communications.

Various forms of media may be involved in carrying one or more sequences of one or more instructions to processor 1804 for execution. For example, the instructions may initially be carried on a magnetic disk or solid-state drive of a remote computer. The remote computer can load the instructions into its dynamic memory and send the instructions over a telephone line using a modem or send the instructions using a network. A receiver, such as a modem, local to computer system 1800 can receive the data and use, for an example, an infra-red transmitter to convert the data to an infra-red signal. An infra-red detector can receive the data carried in the infra-red signal and appropriate circuitry can place the data on bus 1802. Bus 1802 carries the data to main memory 1806, from which processor 1804 retrieves and executes the instructions. The instructions received by main memory 1806 may optionally be stored on storage device 1810 either before or after execution by processor 1804.

Computer system 1800 also includes a communication interface 1818 coupled to bus 1802. Communication interface 1818 provides a two-way data communication coupling to a network link 1820 that is connected to a local network 1822. For example, communication interface 1818 may be an integrated services digital network (ISDN) card, cable modem, satellite modem, or a modem to provide a data communication connection to a corresponding type of telephone line. As another example, communication interface 1818 may be a local area network (LAN) card to provide a data communication connection to a compatible LAN. Wireless links may also be implemented, such as to a wireless local area network (WLAN) or to a cellular network. In any such implementation, communication interface 1818 sends and receives electrical, electromagnetic, radio, optical, and/or other signals that carry digital data streams representing various types of information.

Network link 1820 typically provides data communication through one or more networks to other data devices. For example, network link 1820 may provide a connection through local network 1822 to a host computer 1824 or to data equipment operated by an Internet Service Provider (ISP) 1826. ISP 1826 in turn provides data communication services through the world-wide packet data communication network now commonly referred to as the “Internet” 1828. Local network 1822 and Internet 1828 both use electrical, electromagnetic, or optical signals that carry digital data streams. The signals through the various networks and the signals on network link 1820 and through communication interface 1818, which carry the digital data to and from computer system 1800, are example forms of transmission media.

Computer system 1800 can send messages and receive data, including program code, through the network(s), network link 1820 and communication interface 1818. In the Internet example, a server 1830 might transmit a requested code for an application program through Internet 1828, ISP 1826, local network 1822 and communication interface 1818.

The received code may be executed by processor 1804 as it is received, and/or stored in storage device 1810, or other non-volatile storage for later execution.

### Software Overview

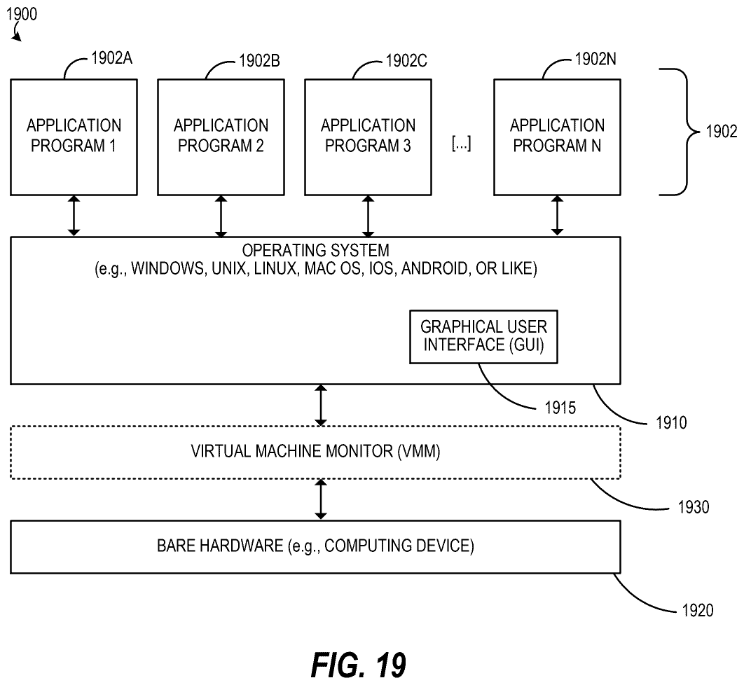

FIG. 19 is a block diagram of a basic software system 1900 that may be employed for controlling the operation of computer system 1800. Software system 1900 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1900 is provided for directing the operation of computer system 1800. Software system 1900, which may be stored in system memory (RAM) 1806 and on fixed storage (e.g., hard disk or flash memory) 1810, includes a kernel or operating system (OS) 1910.

The OS 1910 manages low-level aspects of computer operation, including managing execution of processes, memory allocation, file input and output (I/O), and device I/O. One or more application programs, represented as 1902A, 1902B, 1902C . . . 1902N, may be “loaded” (e.g., transferred from fixed storage 1810 into memory 1806) for execution by the system 1900. The applications or other software intended for use on computer system 1800 may also be stored as a set of downloadable computer-executable instructions, for example, for downloading and installation from an Internet location (e.g., a Web server, an app store, or other online service).

Software system 1900 includes a graphical user interface (GUI) 1915, for receiving user commands and data in a graphical (e.g., “point-and-click” or “touch gesture”) fashion. These inputs, in turn, may be acted upon by the system 1900 in accordance with instructions from operating system 1910 and/or application(s) 1902. The GUI 1915 also serves to display the results of operation from the OS 1910 and application(s) 1902, whereupon the user may supply additional inputs or terminate the session (e.g., log off).

OS 1910 can execute directly on the bare hardware 1920 (e.g., processor(s) 1804) of computer system 1800. Alternatively, a hypervisor or virtual machine monitor (VMM) 1930 may be interposed between the bare hardware 1920 and the OS 1910. In this configuration, VMM 1930 acts as a software “cushion” or virtualization layer between the OS 1910 and the bare hardware 1920 of the computer system 1800.

VMM 1930 instantiates and runs one or more virtual machine instances (“guest machines”). Each guest machine comprises a “guest” operating system, such as OS 1910, and one or more applications, such as application(s) 1902, designed to execute on the guest operating system. The VMM 1930 presents the guest operating systems with a virtual operating platform and manages the execution of the guest operating systems.

In some instances, the VMM 1930 may allow a guest operating system to run as if it is running on the bare hardware 1920 of computer system 1800 directly. In these instances, the same version of the guest operating system configured to execute on the bare hardware 1920 directly may also execute on VMM 1930 without modification or reconfiguration. In other words, VMM 1930 may provide full hardware and CPU virtualization to a guest operating system in some instances.

In other instances, a guest operating system may be specially designed or configured to

execute on VMM 1930 for efficiency. In these instances, the guest operating system is “aware” that it executes on a virtual machine monitor. In other words, VMM 1930 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an laaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving a query for stored data items that have a plurality of attributes that include a first attribute and a second attribute that has a hierarchical relationship with the first attribute;
performing a first sort of the stored data items based on a first set of ordering keys, the first set of ordering keys including the first attribute and the second attribute;
performing a second sort of the stored data items based on a second set of one or more ordering keys, the second set being a proper subset of the first set and including the second attribute as an ordering key;
generating a first sorted structure of the second sort of the stored data items;
inserting first pointers into the first sorted structure, where the first pointers point to the stored data items;
generating a second sorted structure of the second sort of the stored data items; and
inserting second pointers into the second sorted structure, where the second pointers point to the stored data items;
wherein the method is performed by one or more computing devices.

2. The method of claim 1, further comprising returning, in response to the query, information of stored data items pointed to by the first pointers.

3. The method of claim 1, wherein the first sorted structure comprises a hierarchical structure including nodes with the first pointers sorted based on the second attribute, where each node includes at least one pointer to a stored data item.

4. The method of claim 3,
wherein each node of the first sorted structure corresponds to a first attribute value and contains at least one pointer to a unique data item including the first attribute, where the unique data item is unique compared to other data items pointed to by other nodes; and
wherein at least one node of the first sorted structure contains a plurality of pointers, each of the plurality of pointers pointing to a respective data item, where each data item pointed to by a pointer of the at least one node is unique compared to other data items pointed to by a pointer of the at least one node.

5. The method of claim 1, wherein the second sorted structure comprises a hierarchical structure including nodes with the second pointers sorted based on the first attribute.

6. The method of claim 1, further comprising:
comparing a particular first attribute of a particular stored data item to first attributes of stored data items pointed to by the second sorted structure;
determining that the particular first attribute matches a first attribute of a stored data item pointed to by the second sorted structure; and
determining, in response to determining that the particular first attribute matches the first attribute of the stored data item pointed to by the second sorted structure, whether to insert a pointer to the particular stored data item into the first sorted structure.

7. The method of claim 6, wherein determining whether to insert the pointer to the particular stored data item into the first sorted structure comprises:
determining that the pointer to the particular stored data item replaces a pointer to another stored data item in the first sorted structure; and
in response to determining that the pointer to the particular stored data item replaces the pointer to the another stored data item in the first sorted structure:
removing the pointer to the another stored data item from the first sorted structure and from the second sorted structure; and
inserting the pointer to the particular stored data item into the first sorted structure and into the second sorted structure.

8. The method of claim 6, further comprising:
determining that there is insufficient memory to store data items;
spilling data items to disk in on-disk data item sorted sets of rows in response to determining that there is insufficient memory, where the on-disk data item sorted sets of rows are sorted based on the second attribute;
building a data item index for on-disk data items, where the data item index for on-disk data items is sorted based on the first attribute;
comparing the particular first attribute to first attributes in the data item index;
determining that the particular first attribute matches a first attribute in the data item index; and
determining, in response to determining that the particular first attribute matches the first attribute in the data item index, whether to insert the pointer to the particular stored data item into the first sorted structure.

9. The method of claim 8, further comprising:
determining that a new row replaces an existing row identified in the data item index;
adding to a removed row index, in response to determining that the new row replaces the existing row, a removed row identifier of the existing row identified in the data item index; and
ignoring, based on the removed row identifier in the removed row index, an identifier of the removed row in the data item index during comparing the particular first attribute to first attributes in the data item index.

10. The method of claim 1,
wherein the plurality of attributes include a third attribute, and
wherein the method comprises:
performing a third sort of the stored data items based on a third set of one or more ordering keys, the third set including the first attribute and the second attribute as ordering keys;
generating a third sorted structure of the third sort of the stored data items, wherein the third sorted structure comprises a hierarchical structure including nodes that are grouped by the first attribute and sorted based on the second attribute;
inserting third pointers into the third sorted structure, where the third pointers point to the stored data items;
generating a fourth sorted structure of the third sort of the stored data items, wherein the fourth sorted structure comprises a hierarchical structure including nodes that are sorted based on the third attribute and the first attribute; and
inserting fourth pointers into the fourth sorted structure, where the fourth pointers point to the stored data items.

11. One or more non-transitory storage media storing one or more sequences of instructions which, when executed by one or more computing devices, cause:
receiving a query for stored data items that have a plurality of attributes that include a first attribute and a second attribute that has a hierarchical relationship with the first attribute;
performing a first sort of the stored data items based on a first set of ordering keys, the first set of ordering keys including the first attribute and the second attribute;
performing a second sort of the stored data items based on a second set of one or more ordering keys, the second set being a proper subset of the first set and including the second attribute as an ordering key;
generating a first sorted structure of the second sort of the stored data items;
inserting first pointers into the first sorted structure, where the first pointers point to the stored data items;
generating a second sorted structure of the second sort of the stored data items; and
inserting second pointers into the second sorted structure, where the second pointers point to the stored data items.

12. The one or more non-transitory storage media of claim 11, wherein the instructions, when executed by the one or more computing devices, further cause returning, in response to the query, information of stored data items pointed to by the first pointers.

13. The one or more non-transitory storage media of claim 11, wherein the first sorted structure comprises a hierarchical structure including nodes with the first pointers sorted based on the second attribute, where each node includes at least one pointer to a stored data item.

14. The one or more non-transitory storage media of claim 13,
wherein each node of the first sorted structure corresponds to a first attribute value and contains at least one pointer to a unique data item including the first attribute, where the unique data item is unique compared to other data items pointed to by other nodes; and
wherein at least one node of the first sorted structure contains a plurality of pointers, each of the plurality of pointers pointing to a respective data item, where each data item pointed to by a pointer of the at least one node is unique compared to other data items pointed to by a pointer of the at least one node.

15. The one or more non-transitory storage media of claim 11, wherein the second sorted structure comprises a hierarchical structure including nodes with the second pointers sorted based on the first attribute.

16. The one or more non-transitory storage media of claim 11, wherein the instructions, when executed by the one or more computing devices, further cause:
comparing a particular first attribute of a particular stored data item to first attributes of stored data items pointed to by the second sorted structure;
determining that the particular first attribute matches a first attribute of a stored data item pointed to by the second sorted structure; and
determining, in response to determining that the particular first attribute matches the first attribute of the stored data item pointed to by the second sorted structure, whether to insert a pointer to the particular stored data item into the first sorted structure.

17. The one or more non-transitory storage media of claim 16, wherein determining whether to insert the pointer to the particular stored data item into the first sorted structure comprises:
determining that the pointer to the particular stored data item replaces a pointer to another stored data item in the first sorted structure; and
in response to determining that the pointer to the particular stored data item replaces the pointer to the another stored data item in the first sorted structure:
removing the pointer to the another stored data item from the first sorted structure and from the second sorted structure; and
inserting the pointer to the particular stored data item into the first sorted structure and into the second sorted structure.

18. The one or more non-transitory storage media of claim 16, wherein the instructions, when executed by the one or more computing devices, further cause:
determining that there is insufficient memory to store data items;
spilling data items to disk in on-disk data item sorted sets of rows in response to determining that there is insufficient memory, where the on-disk data item sorted sets of rows are sorted based on the second attribute;
building a data item index for on-disk data items, where the data item index for on-disk data items is sorted based on the first attribute;
comparing the particular first attribute to first attributes in the data item index;
determining that the particular first attribute matches a first attribute in the data item index; and
determining, in response to determining that the particular first attribute matches the first attribute in the data item index, whether to insert the pointer to the particular stored data item into the first sorted structure.

19. The one or more non-transitory storage media of claim 18, wherein the instructions, when executed by the one or more computing devices, further cause:
determining that a new row replaces an existing row identified in the data item index;
adding to a removed row index, in response to determining that the new row replaces the existing row, a removed row identifier of the existing row identified in the data item index; and
ignoring, based on the removed row identifier in the removed row index, an identifier of the removed row in the data item index during comparing the particular first attribute to first attributes in the data item index.

20. The one or more non-transitory storage media of claim 11,
wherein the plurality of attributes include a third attribute, and
wherein the instructions, when executed by the one or more computing devices, further cause.
performing a third sort of the stored data items based on a third set of one or more ordering keys, the third set including the first attribute and the second attribute as ordering keys;
generating a third sorted structure of the third sort of the stored data items, wherein the third sorted structure comprises a hierarchical structure including nodes that are grouped by the first attribute and sorted based on the second attribute;
inserting third pointers into the third sorted structure, where the third pointers point to the stored data items;
generating a fourth sorted structure of the third sort of the stored data items, wherein the fourth sorted structure comprises a hierarchical structure including nodes that are sorted based on the third attribute and the first attribute; and
inserting fourth pointers into the fourth sorted structure, where the fourth pointers point to the stored data items.
